(19) United States
(12) Patent Application Publication
(10) Pub. No.: US 2015/0207964 A1
(43) Pub. Date: Jul. 23, 2015

(54) Small UAS With High Definition Video

(71) Applicants: George Bye, Lone Tree, CO (US); Matt Bickel, Denver, CO (US); John W. Brown, Albuquerque, NM (US); Todd Mendenhall, Rancho Palos Verdes, CA (US); Brian S. Goldberg, Ladera Ranch, CA (US); Ryan W. Franz, Boulder, CO (US)

(72) Inventors: George Bye, Lone Tree, CO (US); Matt Bickel, Denver, CO (US); John W. Brown, Albuquerque, NM (US); Todd Mendenhall, Rancho Palos Verdes, CA (US); Brian S. Goldberg, Ladera Ranch, CA (US); Ryan W. Franz, Boulder, CO (US)

(21) Appl. No.: 14/421,436

(22) PCT Filed: Jul. 25, 2013
(86) PCT No.: PCT/US2013/051961

§ 371 Date: Feb. 12, 2015

Related U.S. Application Data
(60) Provisional application No. 61/678,510, filed on Aug. 1, 2012.
(60) Provisional application No. 61/678,514, filed on Aug. 1, 2012.

(51) Int. Cl. H04N 5/225; H04N 5/232

(52) U.S. Cl. CPC H04N 5/2251; H04N 5/232; H04N 5/23241; H04N 5/23248

(57) ABSTRACT

A sensor system comprising specific subassemblies provides high definition video in small unmanned aerial systems. The sensor system provides for efficient space and power utilization.

### TECHNICAL FIELD

The present invention relates to the field of small unmanned aircraft systems (sUASs), and more particularly to high definition video in relation to such sUASs.

### BACKGROUND

Small Unmanned Aircraft Systems (sUASs), which are typically defined as those weighing less than 55 pounds, are increasing in importance in a range of applications, including military, security, surveillance, mapping, law enforcement, border security, drug interdiction and a wide variety of public safety applications. The term Unmanned Aircraft System has risen in use and popularity the past few years as it reflects the fact they are more than just Unmanned Aerial Vehicles, rather a collection of complex integrated systems, in which the Unmanned Aerial Vehicle is one of these integrated systems. sUASs are designed to be launched and recovered from a variety of environments, to be able to stay aloft for long periods, and to communicate in real-time or near real-time over untethered (e.g., radio frequency) communication links. These conditions pose challenges for sUASs, since they must be physically robust, lightweight, energy efficient, and able to communicate over limited bandwidth communication channels.

Many sUASs are used for intelligence, surveillance, reconnaissance and target identification missions. In these missions, it can be important to have high definition video images. High definition video, however, typically requires large volumes of space, large consumption of electrical power and heavy weight in the sUAS for the imaging sensors; requirements that are not compatible with the desired small size and long flight time, especially for man-portable and manual launched sUASs. Also, high definition video typically requires high bandwidth communication channels to communicate the video signal to ground controllers, a requirement that is difficult to meet with limited bandwidth radio frequency communications generally available in sUASs. Also, the sensors, processing, and communications usually incident with high definition video typically require much more electrical power than is desired, especially in small, man-portable and manually launched sUASs.

The present invention provides a sUAS that provides high definition video in a system that is compatible with small size, extended flight, man-portable sUASs.

### BRIEF DESCRIPTION OF THE FIGURES

FIG. 1 provides a schematic and wiring diagram of the components that comprise a sUAS capable of providing high definition video to the sUAS operator. Specifically, it demonstrates the integration of the Electro Optical (EO) high definition camera, Infrared (IR) camera, an Attitude, Heading and Reference System (AHRS) module, a High Definition Video Processing Computer (labeled Video Processing Computer in the diagram), along with the various switches, motors and drives that control the system. It also describes the various electric and electronic inputs and outputs and the type of connection and data feed produced by the various components.

FIG. 2 is an illustration of an example implementation of the electronics.

FIG. 3 is an illustration of an example implementation of the electronics.

FIG. 4 is an illustration of the organization of software that can be suitable with the present invention.

FIG. 5 is an illustration of a circuit board implementation.

FIG. 6 is an illustration of the organization of software that can be suitable with the present invention. Those skilled in the art will appreciate conventional programming tools and techniques for implementing the system illustrated.

FIGS. 7, 8, and 9 are illustrations of software functions in an example embodiment.

FIG. 10 is an illustration of an example embodiment of the present invention.

FIG. 11 is an illustration of the base subassembly.

FIG. 12A, 12B, 12C, 12D illustrate an order of assembly of the base subassembly.

FIG. 13 is an illustration of the access side riser.

FIG. 14 is an illustration of an assembled access side riser.

FIG. 15 is an illustration of the drive side riser subassembly.

FIG. 16A, 16B, 16C, 16D is an illustration of assembly of the drive side riser subassembly.

FIG. 17 is an illustration of the horizontal support subassembly.

FIG. 18 is an illustration of the assembly of the horizontal support.

FIG. 19 is an illustration of the box structure subassembly.

FIG. 20 is an illustration of the assembly of the box structure.

FIG. 21 is an illustration of the camera ball subassembly.

FIG. 22A, 22B, 22C, 22D, 22E, 22F provide an illustration of the assembly of the camera ball.

FIG. 23 14 is an illustration of an example embodiment.

FIG. 24 15 is an illustration of a retraction mechanism used in an example embodiment.

FIG. 25 16 is an illustration of the retraction mechanism in an UAS.

FIG. 26 17 is an illustration of a main circuit board.

FIG. 27 18 is an illustration of an auxiliary circuit board.

FIG. 28A, 28B 19 provide an illustration of a fully assembled example embodiment.

FIG. 29 20 is an illustration of optical switches and stops that can be used to prevent over rotation that could damage cables.

FIG. 30 21 is an illustration of a pan optical switch that can be suitable in some embodiments.

FIG. 31 22 is an illustration of an example embodiment with an alternate tilt motor arrangement.

FIG. 32 23 is an illustration of an example embodiment with an alternate auxiliary circuit board and mount.

### MODES FOR CARRYING OUT THE INVENTION AND INDUSTRIAL APPLICABILITY

The present invention is described in the context of an example embodiment. Those skilled in the art will appreciate that various components and subsystems can be substituted, and the subsets of the example embodiment can be useful in connection with other sUAS.

A UAS with a high definition capability as enabled by the present invention can comprise one or more cameras mounted in a gimbal. A gimbal such as that described in the section below, titled “Gimbal with efficient volume utilization,” can be suitable.

Mounted with the gimbal can be cameras such as the FLIR Tau---2 640 LWIR Camera with Fixed 18 deg FOV, 640×480 resolution; and the Sony FCB---EH3150 High Definition EO camera with 4.6 to 53.4 deg FOV with continuous zoom. The gimbal can also have High Precision two axis gimbal with onboard gyro---stabilization & resolvers mounted with it. An onboard Video Processing Computer and control processors can also mount with the gimbal, and provide target tracking, compression, stabilization; and inertial pointing, inertial stabilization, target tracking, and geo---pointing modes. The onboard Video Processing Computer can provide a multi-target tracker, digital image stabilization, and video encoding.

Image stabilization is a critical aspect of an ISRT mission. It can be critical to success to resolve a person at a 400-meter (m) distance from the sensor. No presently available gimbal suitable for small size (less than 7″ camera ball), low power, manual launch, extended flight can achieve this. The example embodiment, however, meets this critical mission requirement in both the EO and IR mode. This specification provides a yardstick from which to scale the entire system. It has been determined that human detection at 400 m requires a useable IFOV (Instantaneous Field of View) of ˜2 feet. The camera resolution, optics speed, and pixel stabilization must all mutually support that goal. Pixel count or gimbal pointing resolution do not individually suffice to meet the mission requirement. The present invention provides unique technology and system features that enable the gimbal system to deliver better performance from an equivalent optic to achieve optimal resolution performance. Some of the additional features and benefits provided by the present invention can include:

Miniature IMU onboard the gimbal: cues target tracking algorithms, geo-references the line of sight (LOS), provides gimbal stabilization feedback, and eliminates need for aircraft/gimbal calibration.

The onboard Video Processing Computer driven Image processing: onboard target tracking drives gimbal pointing loops. Real-time image stabilization removes high frequency LOS jitter even beyond mechanical control loop bandwidth.

The onboard Video Processing Computer driven Signal processing: downlink stream compression. HD video inset. Overlays metadata and enables use of a High Definition camera.

Control mechanism: stabilizes gimbal with aircraft rate feed---forward, removing disturbances before they get to the gimbal mechanism.

The benefits are perhaps most obvious when considering the delivered IFOV. At the maximum zoom setting of 5.4 deg FOV, the HD camera's 1024 pixels subtend 92 Rad, which provided better resolution than that required to resolve an individual at 400 m. Even at maximum wide angle (50 deg FOV), the sensor still meets this resolution requirement with a significant margin. In addition, the system will provide the sUAS operator with a wide angle scene context. The IR camera has fixed 18 deg FOV and 640 pixels for IFOV, which also meets than the resolution requirement.

The pixels are individually resolvable because of the dual compensation from gyro stabilization and the onboard Video Processing Computer enabled image processing. The H.264 video compression, which as stated previously is enabled by the onboard Video Processing Computer, provides both whole scene, and an HD inset of the target zone that are downlinked, along with metadata such as real time line of sight. The present invention provides the only gimbal in its size, weight and power class with built in computational capability to do image processing before video is downlinked to a ground control station or operator. It uniquely preserves limited RF bandwidth yet still allows full HD 1080p stabilized images to be sent to the operator or ground control station. This results in unmatched EO and IR resolution and image processing and can perform functions unavailable in any gimbal in its size and weight range.

The processing modules fit inside the gimbal casing and are integrated with the electronics and cameras. The inclusion of the onboard Video Processing Computer provides a unique “integrated in the gimbal” state-of-the-art solution for image processing with extraordinary advanced features including multiple target tracking, image stabilization, video conversion, digital zoom and H.264 video encoding and multi-camera image fusion.

A suitable camera is Sony's newest HD block camera, the FCB EH3150. This camera was introduced by Sony in early 2012 and has performance characteristics that exceed other similar cameras. Specifically, the EH3150 provides:

Excellent high---definition (HD) picture quality

The Exmor CMOS sensor realizing high image quality and high sensitivity

Powerful zoom capability

Bright, fast, and robust 28× zoom lens

Image Stabilization*2: an image---stabilization function which minimizes the appearance of shaky images caused by low---frequency vibration.

StableZoom™, a function for performing correction using the image stabilization function in accordance with the zoom ratio, and smoothly zooming up to approximately ×33 using a combination of the optical zoom and digital zoom.

Video mode changes on the fly. Without any power cycle, this function makes it possible to change the video mode, for example, from 1080p/29.97 to 720p/59.94 mode.

A suitable IR camera is the FLIR Tau-2 640 fitted with a 35 mm lens. The TAU-2 640 is an industry standard IR camera with exceptional capabilities.

In addition to the EO and IR cameras, example embodiments can be fitted with an optional laser pointer/designator for precision target location and identification.

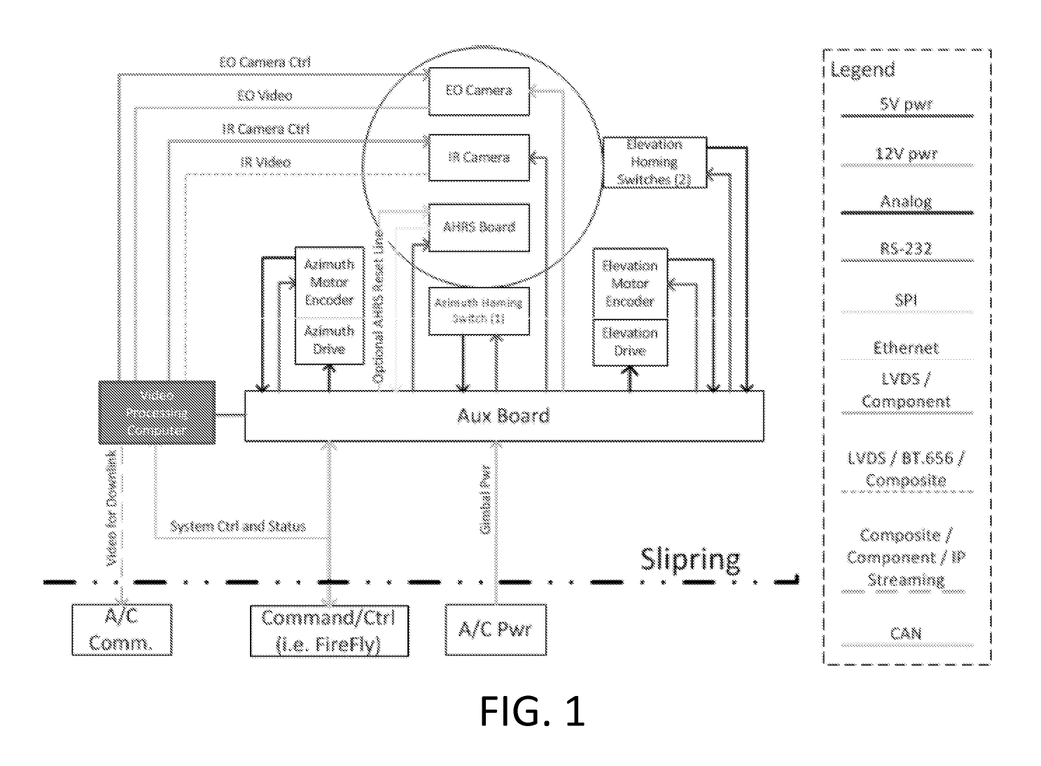

FIG. 1 is an illustration of the electronics of an example embodiment. Those skilled in the art will appreciate conventional design and fabrication techniques to realize the system described.

The present invention can provide several features, in hardware or software, to help reduce power. As examples:

To reduce power usage during takeoff and landing:
Aux board can switch off power to both cameras
Aux board can short motor windings, providing braking; may be adequate for takeoff and landing without actively holding gimbal axes with motors
Autopilot can command Video Processing Computer board into power saving state

To reduce power usage in the air:
Aux board can turn off EO focus and aperture motors

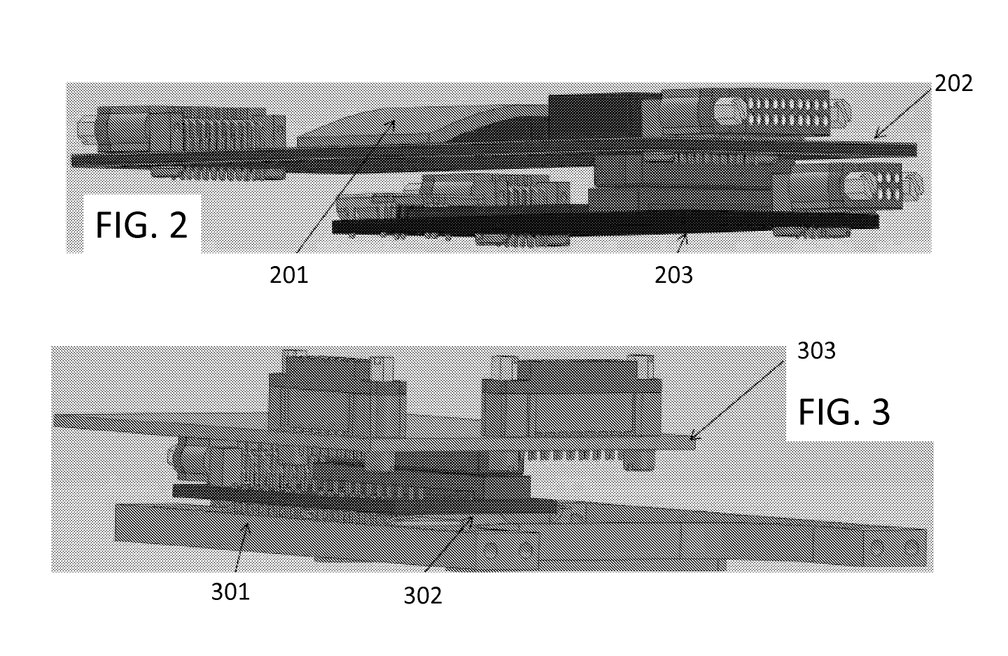

FIG. 2 is an illustration of an example implementation of the electronics. The system is split into two circuit boards to more readily accommodate the space constraints. One is the Video Processing Computer (Green), or Main board or Motherboard; the other is the Daughter board (Blue). This also provides flexibility to accommodate various video interfaces. The example embodiment comprises a Heatsink for DSP tied to thermal Ground Plane 100; a Video Processing Computer, also referred to as Main board or Mother board, used for Communication and Video Processing 101; and Daughter board, for Video Interfaces 203 (allows computational power of Main Board to be saved).

FIG. 3 is an illustration of an example implementation of the electronics. This subsystem is also implemented as an Auxiliary two board system, with processor, power regulation, and power switching on one board (Yellow); and motor drive circuitry on the second board (Red). This allows easier accommodation for various motor types with minimal redesign. The example embodiment comprises Motor chips tied to Horizontal Support for thermal dissipation 301; Motor Board (Red) or Motor Drive Board (the second of the Two Board Aux Configuration) 302; and Auxiliary Board (Yellow), or Main Board (Of Two Board Aux Configuration) allows for Processor, Sensor Interfaces and Power 303.

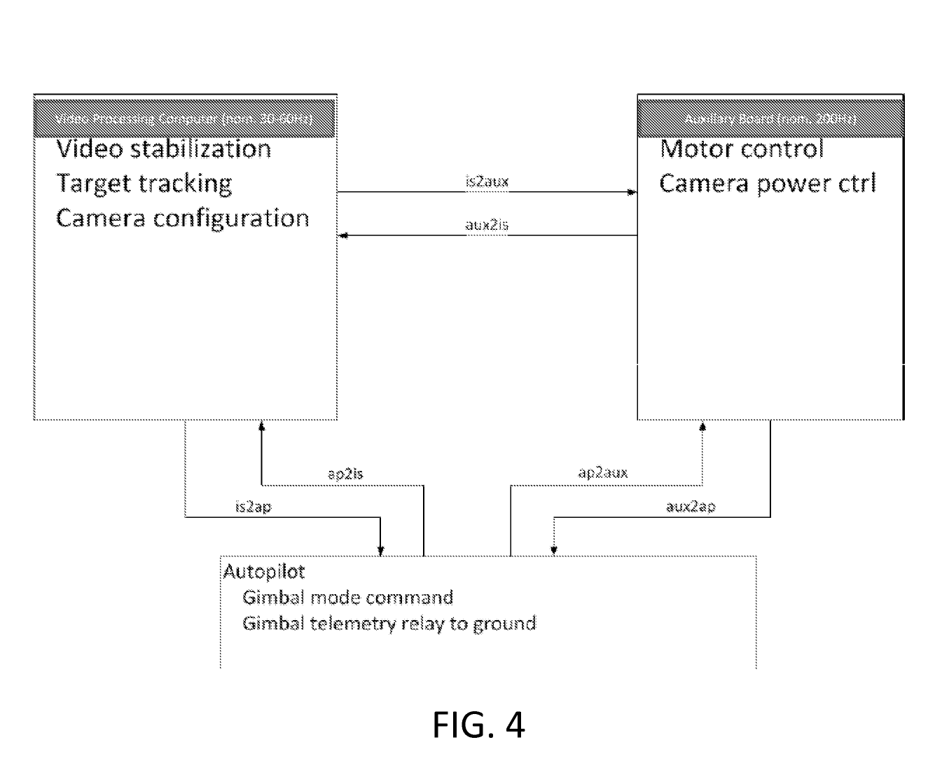

FIG. 4 is an illustration of the organization of software that can be suitable with the present invention. Those skilled in the art will appreciate conventional programming tools and techniques for implementing the system illustrated.

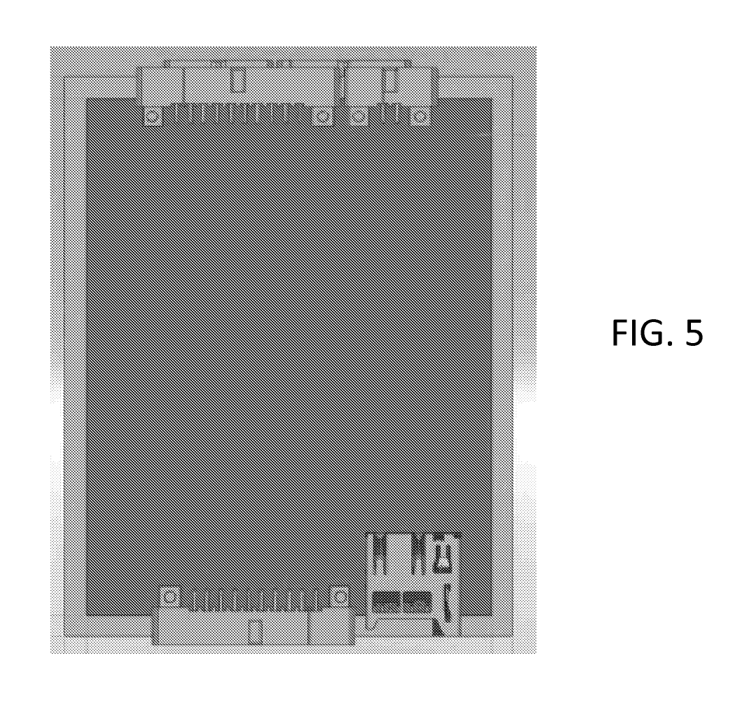

FIG. 5 is an illustration of a circuit board implementation. HDMI and component video inputs are provided. A thermal plane with conductive ring is provided for heat extraction. The example board, which is the Video Processing Computer (Green), has been tested to operate in −45 to 80 degrees C. A microSD card is provided on the board to on-board recording. The board can support multiple cameras simultaneously. The example is 3.25 inch by 2.6 inch in size.

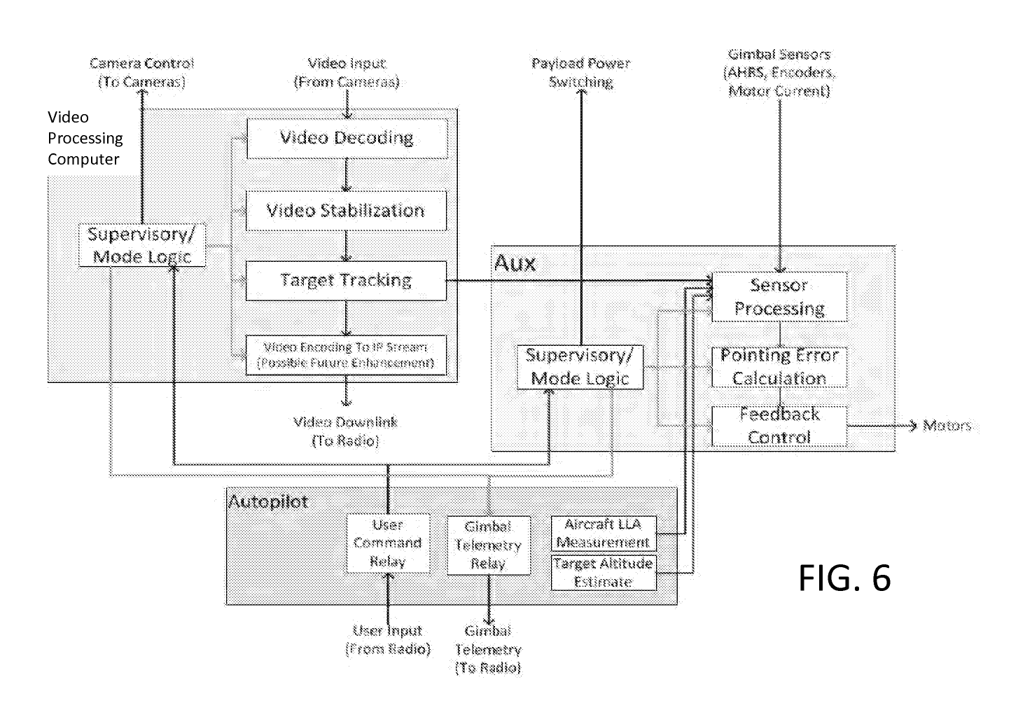

FIG. 6 is an illustration of the organization of software that can be suitable with the present invention. Those skilled in the art will appreciate conventional programming tools and techniques for implementing the system illustrated.

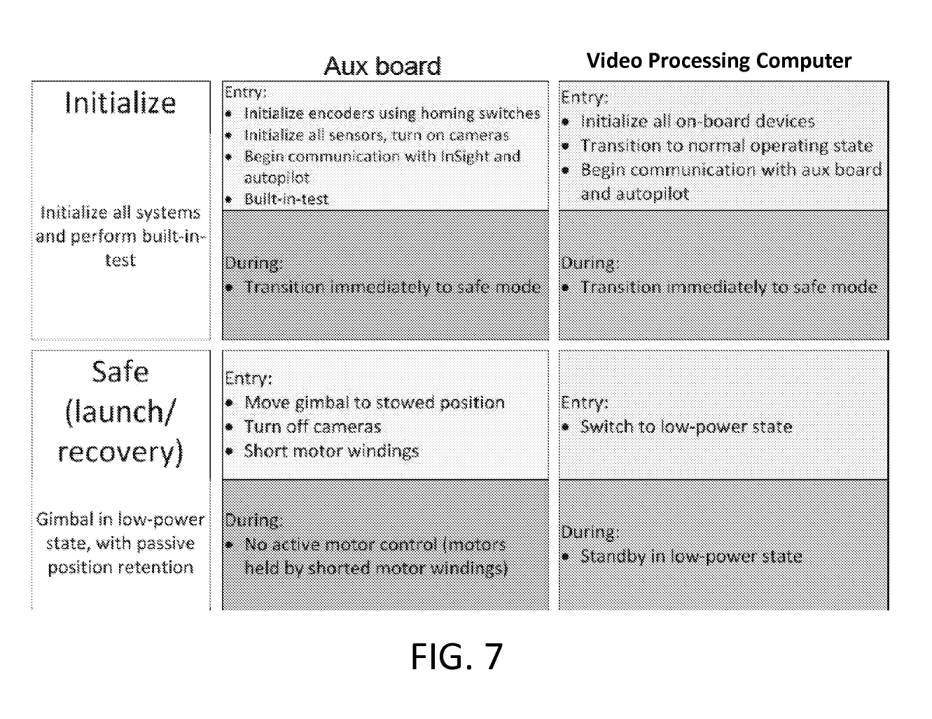

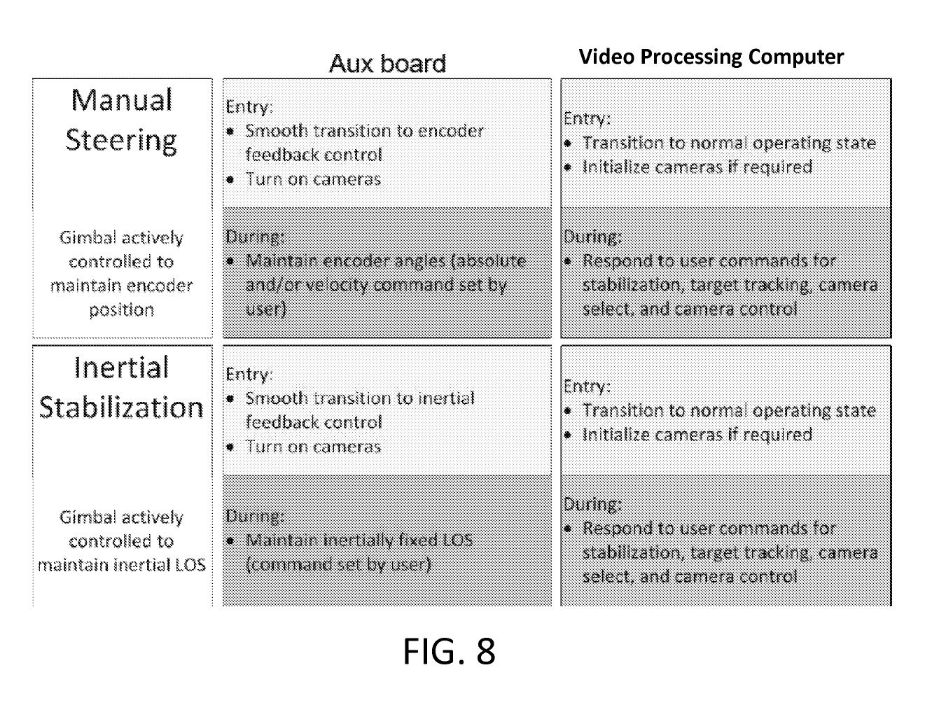

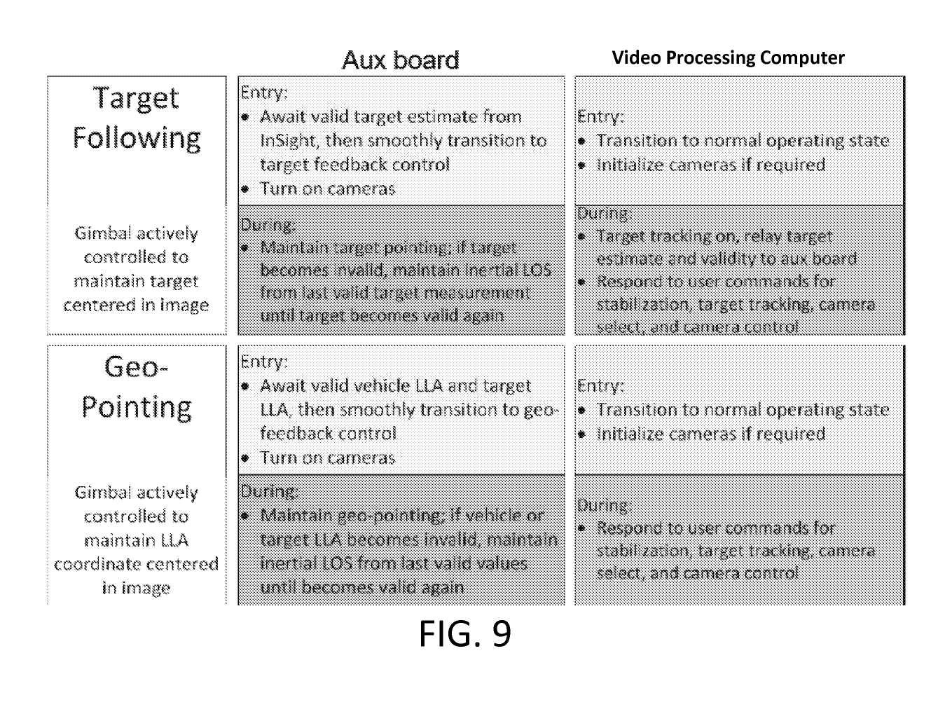

FIGS. 7, 8, and 9 are illustrations of software functions in an example embodiment. Those skilled in the art will appreciate conventional programming tools and techniques for implementing the system illustrated.

Gimbal With Efficient Volume Utilization.

Unmanned aerial vehicles (UAVs) are increasing in importance in a range of applications, including military, security, surveillance, mapping, law enforcement, border security, drug interdiction and a wide variety of public safety applications. Today the term Unmanned Aircraft System (UAS) is being used more and more to reflect the fact that these are more than just Unmanned Aerial Vehicles, rather a collection of complex integrated systems. These integrated systems include the Unmanned Aerial Vehicle, the Ground Control Station, radios, an operator, etc., but because the data imagery is so instrumental to the performance of the UAS mission, no integrated system is more important than the onboard sensor package. In many applications, it is important that the UAS be able to capture data from sensors such as cameras, and to be able to direct those sensors to particular orientations relative to the UAS. As an example, a UAS operator might desire to direct particular attention to a structure or vehicle, and consequently need to continuously adjust the orientation of a camera relative to the UAS as the UAS moves relative to the structure or vehicle.

Sensors in such applications are mounted in structures commonly called gimbals. Gimbals provide for secure mounting of the sensor with the UAS; communication of information from the sensor to the UAS, to remote monitors, or both; and controllable adjustment of the sensor orientation relative to the UAS. Gimbals are also used in other applications, for example for controllable sensors in manned flight and in fixed, ground-based security systems. While the present description generally assumes a UAS application for ease of description, the present invention is not limited to UAS applications and includes all applications where gimbals are suitable.

FalconVision™: There are 10 other known sensor gimbals that are roughly in the SWaP (Size Weight and Power) class of FalconVision™—the D-Stamp, D-Stamp HD and M-Stamp made by Controp, the Cobalt 90 made by FLIR, the Tase200 made by CloudCap, the Otus L170 made by DST, the Skyshark made by AME, the Mantis i25AE made by Aerovironment, the Perceptor TM 88× made by Procerus Technologies, and the CAM/IR 2208D-Aerial Series made by Infrared, Inc.

The FalconVision™ gimbal has higher performance characteristics than any of the systems in its direct SWaP category, and it has performance characteristics that are very comparable in the 7 in Ball Diameter or larger SWaP range. However, to rely solely on the specs for pointing stability, slew rate, range of motion, etc. as a basis of comparison would be missing out on what the markets for Airborne ISRT and Ground Situational awareness are demanding.

What these markets really want and the major shortcomings of the gimbals in this SWaP class are high performance HD imaging capabilities at heights above 1000 ft AGL (Above Ground Level), which are characteristics usually reserved for much larger and more expensive gimbals. Most Gimbals in this SWAP class often have a hard time meeting the optics requirements to even see anything above 1,000 ft AGL, much less High Definition (HD) video. Of the gimbals in this SWaP class that do have HD capabilities they require an external heading and referencing source for Geo-Location and Geo-Tracking. FalconVision™ is the first gimbal in its class that has been able to meet the heading and heavy referencing requirements of these characteristics without sacrificing optics and performance characteristics needed to see at those heights. In fact, FalconVision™ is able to deliver real time HD imagery from the most technologically advanced cameras in its class in a dual imager package that contains both an E/O and IR camera without a change in payload.

The present invention provides a two axis gimbal with several important advantages over previous gimbals. Embodiments of the present invention can accommodate sensors and image processing systems in the gimbal itself, providing increased packing density, higher system reliability, and increased communication efficiency. Embodiments of the present invention can provide high performance over a wide range of temperatures, providing an ability to accommodate sensors with varying thermal characteristics without requiring separate cooling systems or separate heating systems. Embodiments of the present invention can provide an on-board Attitude and Heading Reference System (AHRS), enabling high performance inertial stabilization, geo-pointing, and geo-location. Embodiments of the present invention can accommodate interoperable dual imagers (e.g., imagers for use in day and night conditions), allowing a wide range of operations without requiring changers in payload.

An example embodiment of the present invention provides a gimbal with an unparalleled combination of small size and superior performance characteristics allowing for High Definition dual imager capabilities in a 5″ class low SWaP (Size Weight and Power) gimbal. The example embodiment provides high definition sensing abilities without sacrificing performance and optics; advanced capabilities previously only available in much larger and expensive gimbals. The example embodiment includes an Onboard Video Processing Computer, which provides capabilities only found in much larger class gimbals such as High Definition Electro Optic sensing, video stabilization, target tracking, and selective imagery data compression.

An example embodiment includes Onboard Attitude and Heading Referencing System (AHRS) for high performance inertial stabilization, geo-pointing, and geo-location; which is a critical function for targeting, location reference and target tracking. When paired with an optional laser pointer, these capabilities can be expanded to include target geo-pointing and geo-referencing.

An example embodiment includes the following features:
Dual imagers (day/night use without payload change)
2 gyro axis inertially stabilized
HD Electro Optic Sensing Capabilities
Onboard Video Processing
Onboard Attitude Heading and Referencing System (AHRS)
Gimbal retraction
Image Stabilization
Target Tracking
Geo-Location
Geo-Pointing

Other embodiments can include one or more of the following features:
Multi-target tracking
Auto-Zoom
H.264 Video Encoding
SWIR Imager
HD-SDI Data Output
Laser Pointer
Laser Range Finder
High Altitude Operation (>12,000 ft MSL)

Future enhancements and features in development include:

Multi-Camera Image Fusion

Moving Target Indicator

An example embodiment of the present invention comprises a system as illustrated herein, with the following specifications:

| Feature | Specification | | |
|---|---|---|---|
| Weight | 1.5 kg or less | | |
| Size | 5.25″ or less diameter × 9.0″ tall; | | |
| Average Power, Peak Power | 22 W or less average; 30 W or less peak | | |
| Dual Imagers | LWIR/EO | | |
| LWIR Camera; zoom | FLIR Tau-2 640, 35 mm lens, 4x digital zoom | | |
| LWIR Camera FOV; Resolution | 18 degrees; 640 × 480; | | |
| | | Vehicle | Human |
| LWIR Target Resolution | Detection | 2550 m | 960 m |
| | Recognition | 680 m | 245 m |
| | Identification | 340 m | 122 m |
| EO Camera | Sony HD Block Camera FCB H11 (other cameras available) | | |
| EO Camera FOV | 5.4-53.4 degrees | | |
| EO Resolution | 1920 × 1080 | | |
| | | Vehicle | Human |
| EO Target Resolution | Detection | >1500 m | >700 m |
| | Recognition | >1000 m | >500 m |
| | Identification | >700 m | >350 m |

| | |
|---|---|
| EO Zoom | 4x digital + 12x optical (EO camera selection dependent) |
| Maximum Slew Rate | 120 degrees/second; |
| Range of Motion | Continuous pan; −90 to 90 degrees tilt |
| Pointing Modes | Manual steering with or without stabilization |
| | Inertial pointing with stabilization |
| | Target tracking |
| Pointing stability | 500 urad |
| Video Processing | Vehicle and human target tracking and digital image stabilization |
| | Video inlay (picture-in-picture) of a selected target of interest |
| | Video output in component or NTSC format |
| | <100 ms latency |
| Power Interface | 12-24 Volts DC power |
| Command, Control Interface | CAN, RS-232 or Ethernet |
| Video Interface | Component (High Definition), NTSC, or H.264/MPEG-2 |
| | IP Stream |
| Gimbal Connector | Single 25-pin micro-D connector |
| Temperature Range (ops) | −30/+60 degrees C; provided minimum airspeed of 15 knots is |
| | maintained |
| Weather | Operable in light rain and dust |

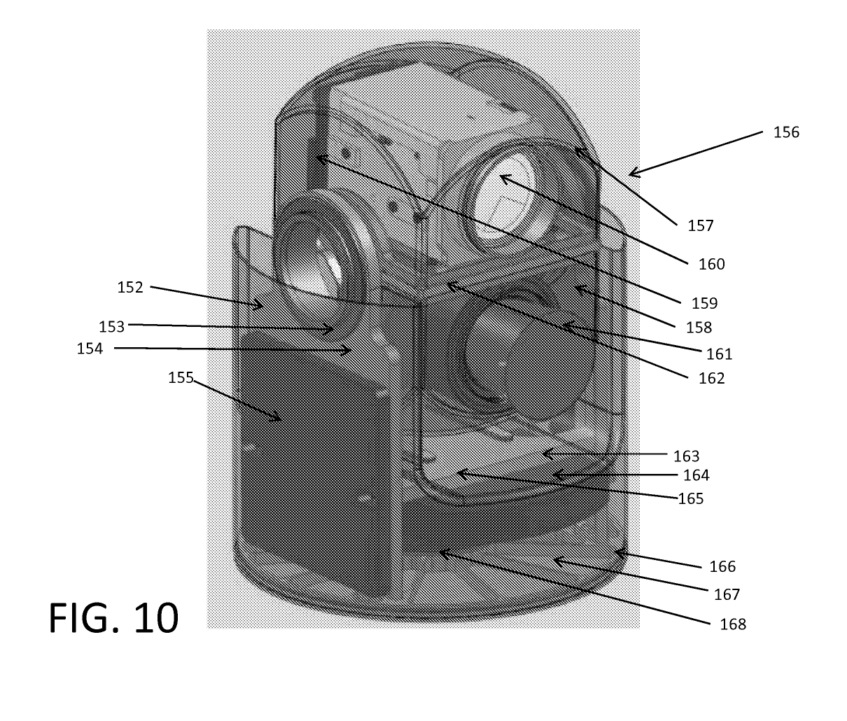

FIG. 10 is an illustration of an example embodiment of the present invention. Each of the 5 Subassemblies is shown, and the parts in each Subsystem that can be seen are listed. If a special material or color is shown it is noted. The example embodiment uses structural elements for stiffness as well as managing heat flow. The embodiment can be assembled as subassemblies, with components in each subassembly grouped for complete functions, which allows testing at subassembly level before final assembly. The example comprises: top pulley 151; an access side riser subassembly 152 comprising bearing 153, riser frame 154, and video processing computer 155; a camera ball subassembly 156 comprising an IR shell (carbon fiber material 157, a visible shell (carbon fiber material) 158, a digital interface board (aegis) 159, a visible light camera 160, an IR camera 161, and a camera ball structure 162; a horizontal support subassembly 163 comprising an auxiliary board 164 and a horizontal support 165; and a base subassembly 166 comprising a base 167 and a center pulley 168.

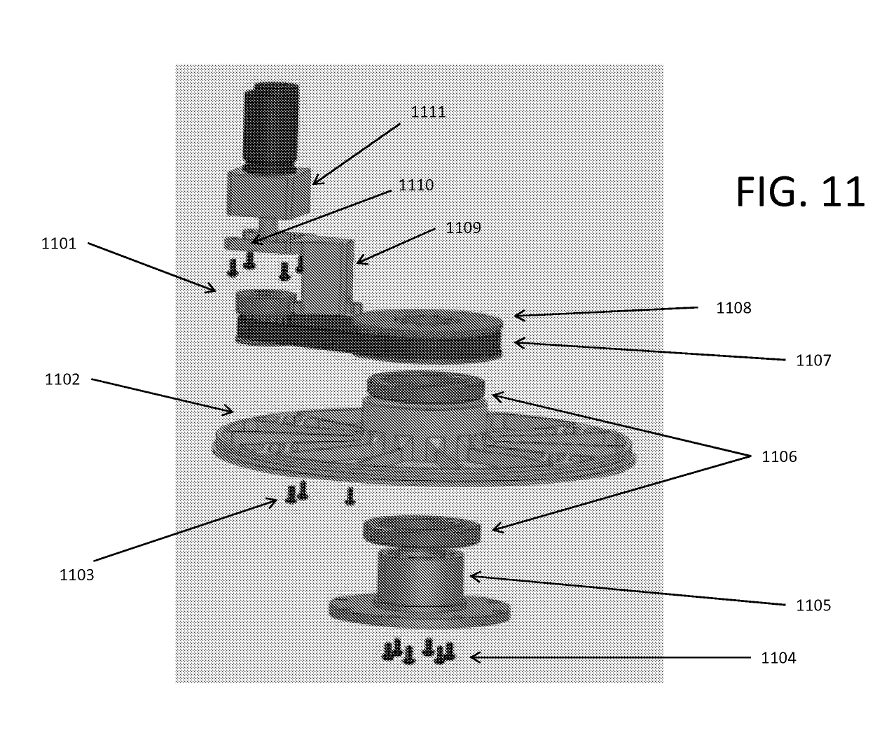

FIG. 11 is an illustration of the base subassembly. The base subassembly provides a structural interface to the shell (e.g., made of carbon fiber or other light weight but structurally strong material) and risers and a torque interface to the pan axle. The shell covers the entire Box Structure Subassembly, which comprises most of the apparatus except the Camera Ball Subassembly. The base subassembly comprises a pan drive motor 1101, a base 1102, three screws 1103 to install the bracket, six 2 mm screws 1104 to install the pan axle, a pan axle 1105, press fit bearings 1106, a belt 1107, a center pulley 1108, a bracket 1109, 4 screws 1110 to install the pan drive motor into the bracket 1109, and a pan drive motor 1111.

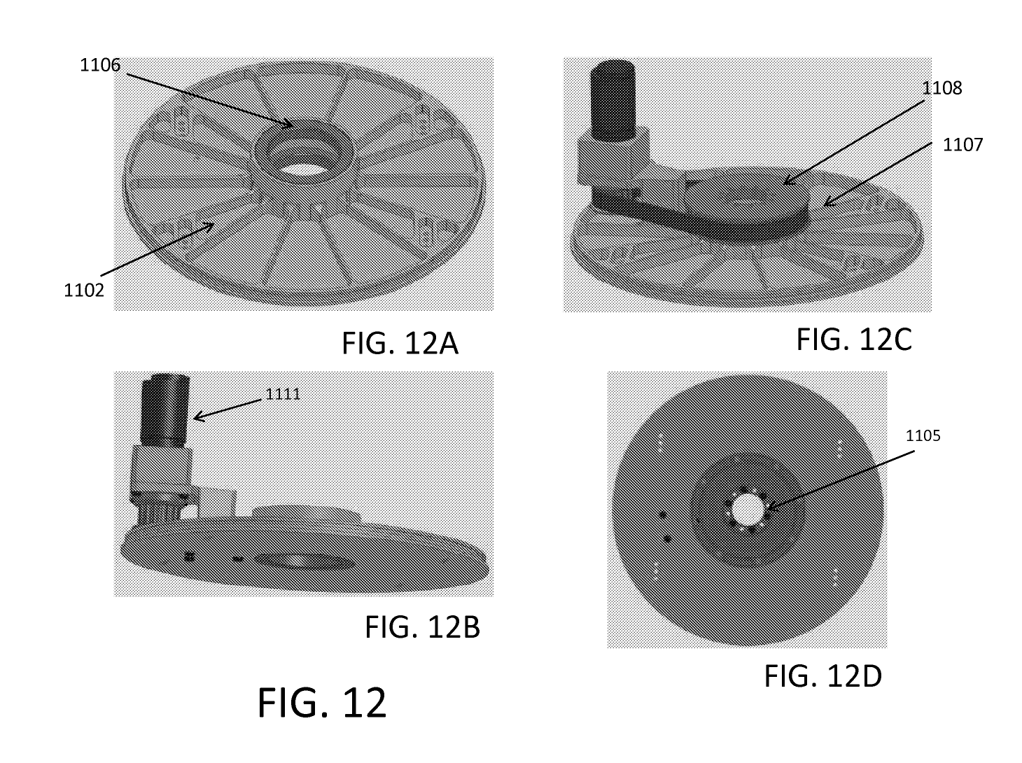

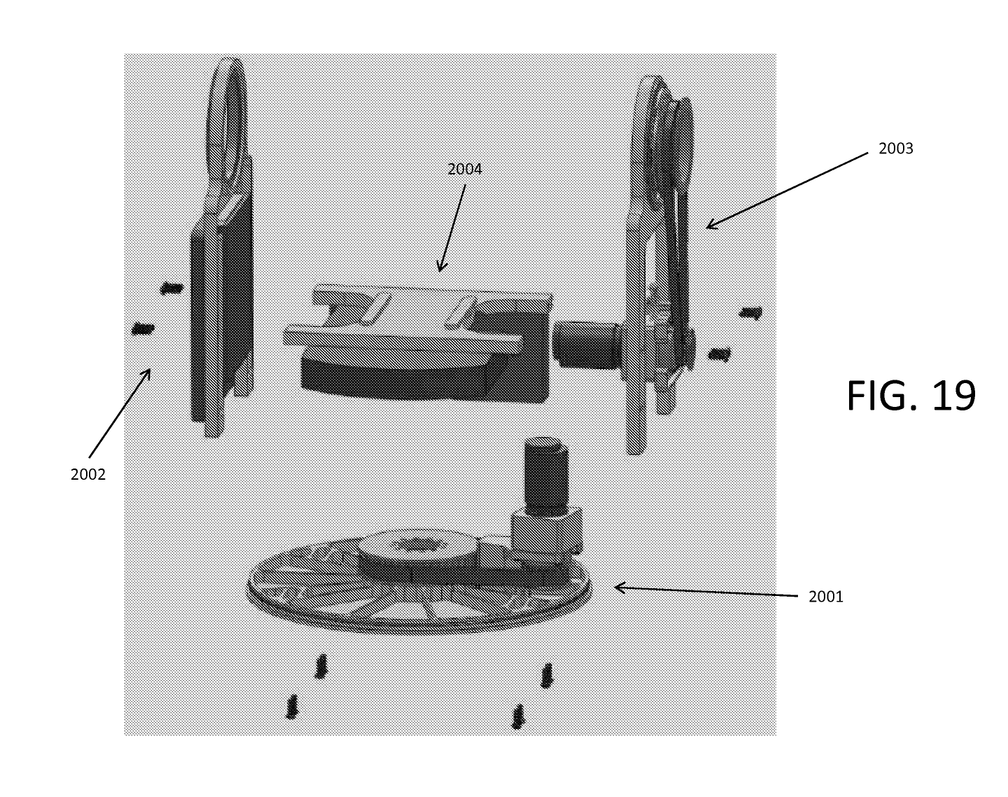

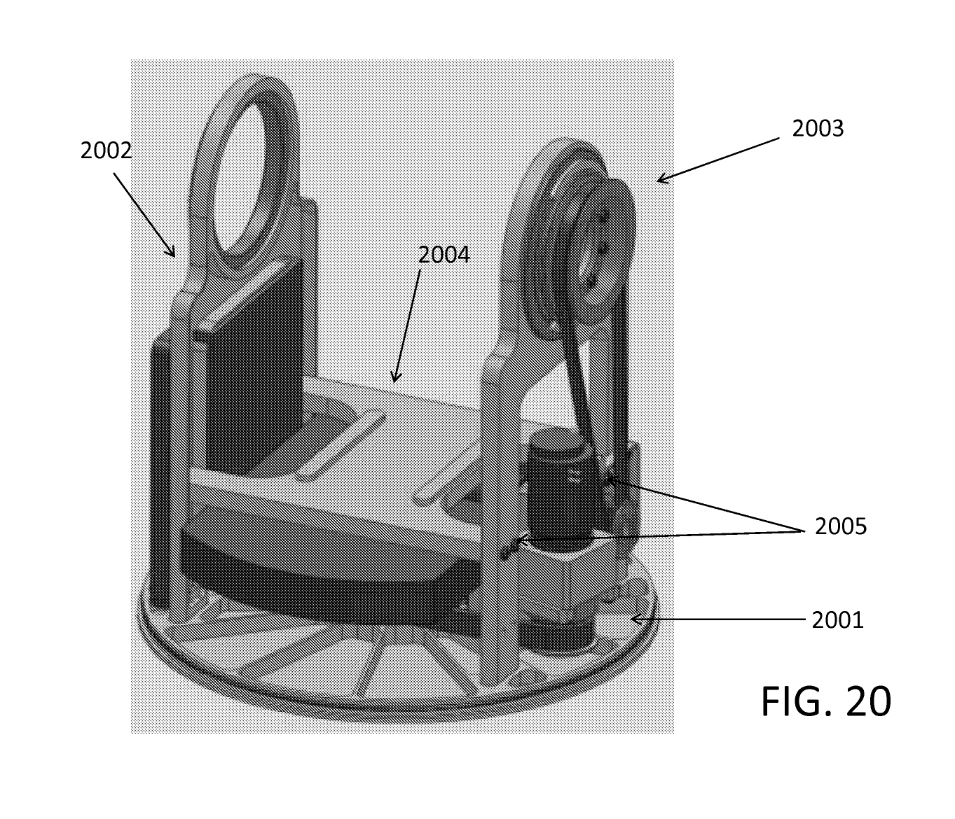

FIGS. 19 and 20 illustrate the Box Structure Subassembly, which comprises: the Base Subassembly 2001, the Access Side Riser Subassembly 2002, the Drive Side Riser 2003, and the Horizontal Support Subassembly 2004, and eight 2 mm screws 2005 for attaching the horizontal board. In FIG. 10, it can be seen that the shell doesn't cover the Drive Side Riser so that the Camera Ball Subassembly can attach and move freely. The Pan Axle can be seen in FIG. 11 and is marked, and FIG. 12D being screwed in. Since it is screwed in under the Base Subassembly it is only visible in those two slides. Excessive height of the gimbal can be undesirable; in the example embodiment the pulley is counter bored to cover multi-load bearings and structure to accommodate the desired separation between bearings. The pan drive for the gimbal is mechanically self-contained on the base subassembly. Desired tension can be provided by an external roller or an internal pulley. FIG. 12A-FIG. 12D illustrates an order of assembly of the base subassembly. In FIG. 12A, the bearings are installed, for example by press fitting or by slip fitting with a retainer such as a sleeve. In FIG. 12B, the pan drive motor is installed on its bracket, for example with 4 2 mm screws. The pulley is installed on the motor shaft, for example with a set screw with sleeve retainer. The bracket is installed on the base, for example with 3 2 mm screws. In FIG. 12C, the belt and center pulley are installed. The center pulley is configured to go about 50% into the top bearing. The belt can be loose at this stage. In FIG. 12D, the pan axle is installed, for example with 6 2 mm screws. The lower bearing interface can be shimmed to slightly axially preload the bearings. The pan drive belt is tensioned, and can be checked with a belt tension meter.

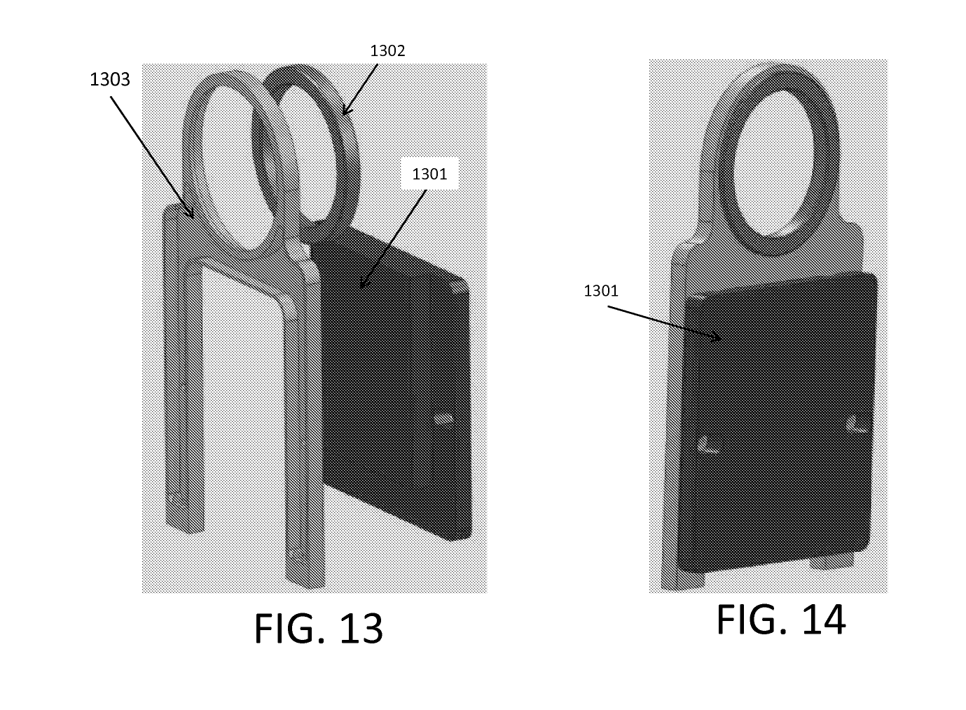

FIG. 13 is an illustration of the access side riser. Note the onboard video processing computer 1301. The integration of the video processor into the gimbal is a major technical advantage over all of the other gimbals in this SWaP (Size Weight and Power) class, because it allows for High Definition Video Imagery to be processed onboard the gimbal. Other gimbals have to downlink their Video processing capabilities, which means they don't have the bandwidth to process HD and keep their other performance characteristics. The access side riser comprises a thin multiload bearing 1301 and a riser frame 1303.

FIG. 14 is an illustration of the assembly of the access side riser. The bearing is installed, for example by press fitting or by slip fitting with a sleeve retainer. The Video Processing Computer 1301, shown in green in the figure, for the control electronics and on-board image processing is installed (this can be installed at a later stage of the overall gimbal assembly, if desired). A Daughter Board can be installed in the Access Side Riser to free up the computing power of the Video Processing Computer, or the main board. The “Daughter Board” has been installed to do video interfacing, allowing the main Video Processing Computer to focus its computing power on Video Processing and Communications, this will allow greater capability and flexibility in Video Interfacing if later customization or extension of the apparatus is desired.

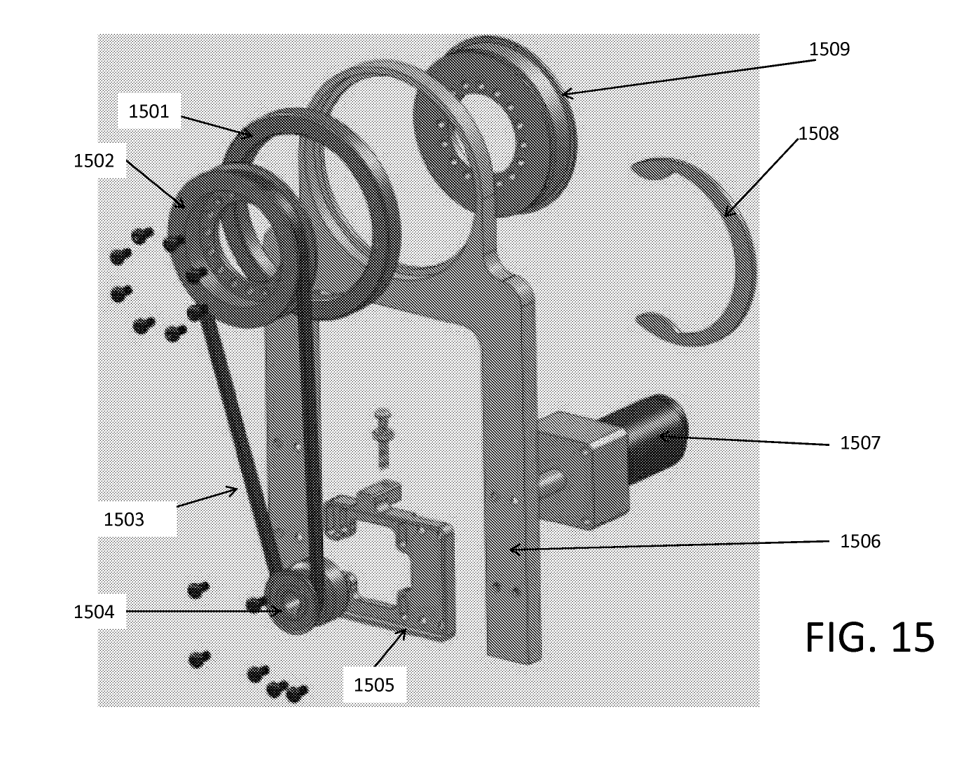

FIG. 15 is an illustration of the drive side riser subassembly. The subassembly comprises a bearing 1501, a top pulley 1502, a belt 1503, a pulley 1504, a bracket 1505, a riser frame 1506, a tilt drive motor 1507, a C clip 1508, and a drive side tilt axle 1509. This subassembly contains the self-contained tilt drive, and can be assembled and tested independent of the rest of the gimbal. Note that the bearing bore is large, due to access requirements and required space for the tilt ball frame. If a smaller bearing is used, the pulley could serve instead of the retaining clip. The tilt drive motor can be mounted lower on the riser frame to allow more room for electronics in the gimbal. The drive belt tension can be adjusted with the offset screw. Final assembly can increase the belt tension slightly, so tension at subassembly can be set to the lower end of the desired range.

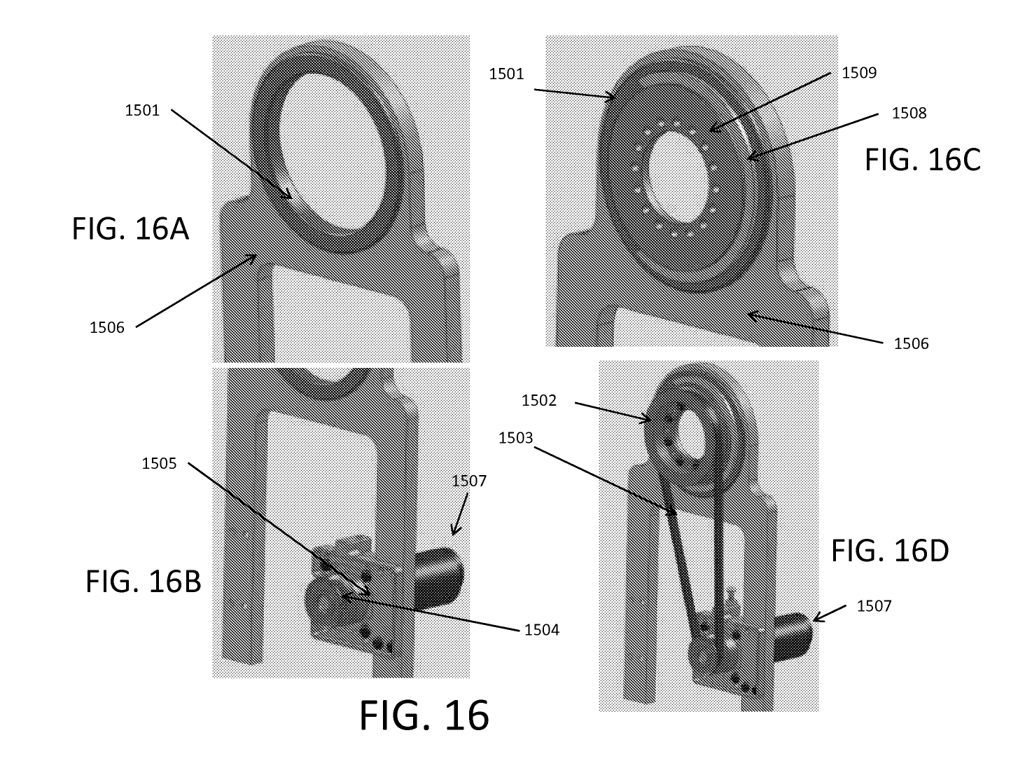

FIG. 16A-FIG. 16D is an illustration of assembly of the drive side riser subassembly. In FIG. 6A, the bearing 1501 is installed, for example by press fitting or by slip fitting with a sleeve retainer. In FIG. 16B, the tilt drive motor 1507 is installed on its bracket, for example with 4 2 mm screws. The pulley 1504 is installed on the motor shaft. The bracket 1505 is installed on the base, for example with 2 2 mm screws. Only the lower screws need be installed at this stage, since the back side registration flat will restrain the bracket. In FIG. 16C, the drive side tilt axle 1509 is installed. A C-clip 1508 retains the axle. A shim can provide a small preload to the inner bearing race. In FIG. 16D, the belt 1503 and top pulley 1502 are installed, for example with 6 2 mm screws. The belt should be loose at this stage. The belt is then tensioned to the lower end of the desired range, and tensioned checked with a belt tension meter. Care should be taken to avoid belt tension that would result in damage, for example due to oscillations at the natural frequency.

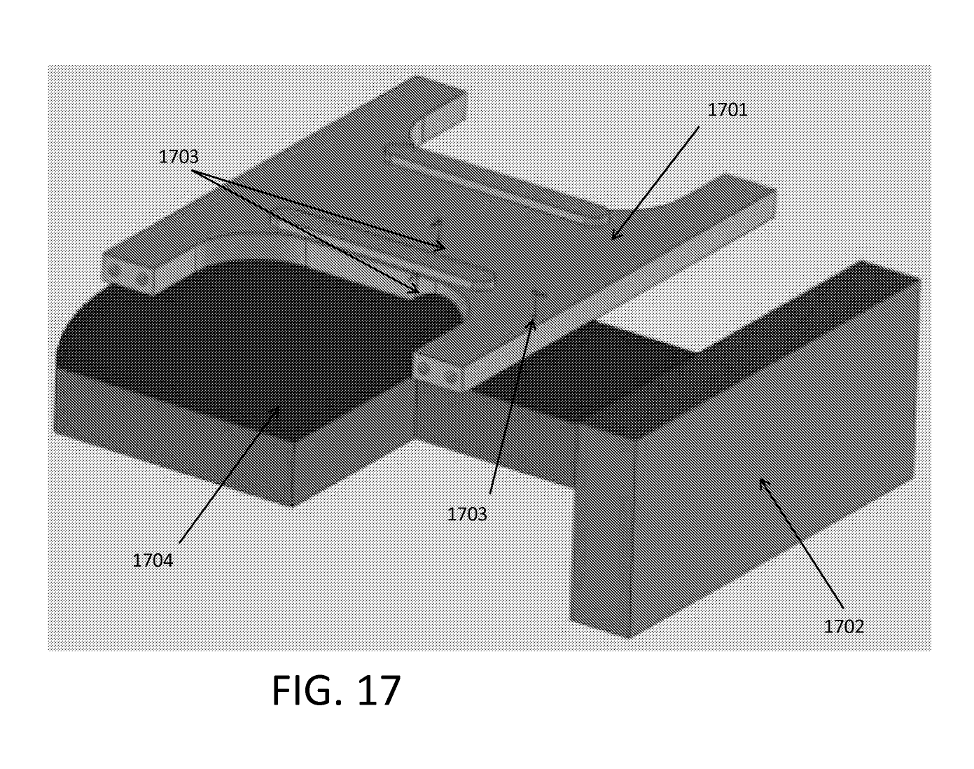

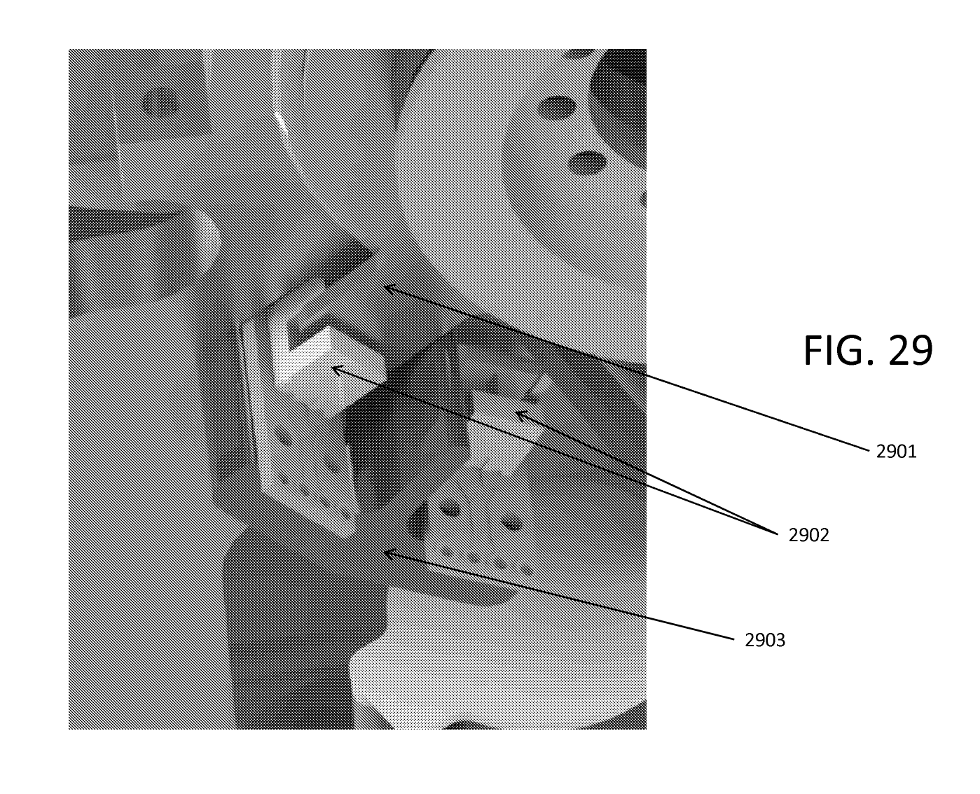

FIG. 17 is an illustration of the horizontal support subassembly. The subassembly comprises a horizontal support 1701, a drive board 1702, attachment points for the drive board 1703, an auxiliary board 1704. In FIG. 29, auxiliary board 1704 is referred to as Main Board, or the Main Board of the Auxiliary two board configuration. It is also shown as Yellow from that figure on. The drive board 1702 is also referred to as Motor Board or Motor Drive Board. In FIG. 29, the Drive board is actually Shown mounted to the base. The horizontal support is used to complete the lower box structure, and provides attachment ports for the auxiliary board and the drive board. It also provides the prime thermal path to external air. Two raised pads are used to both hold the external shell and to conduct heat. The external clamp pieces can be changed to conduct more or less heat.

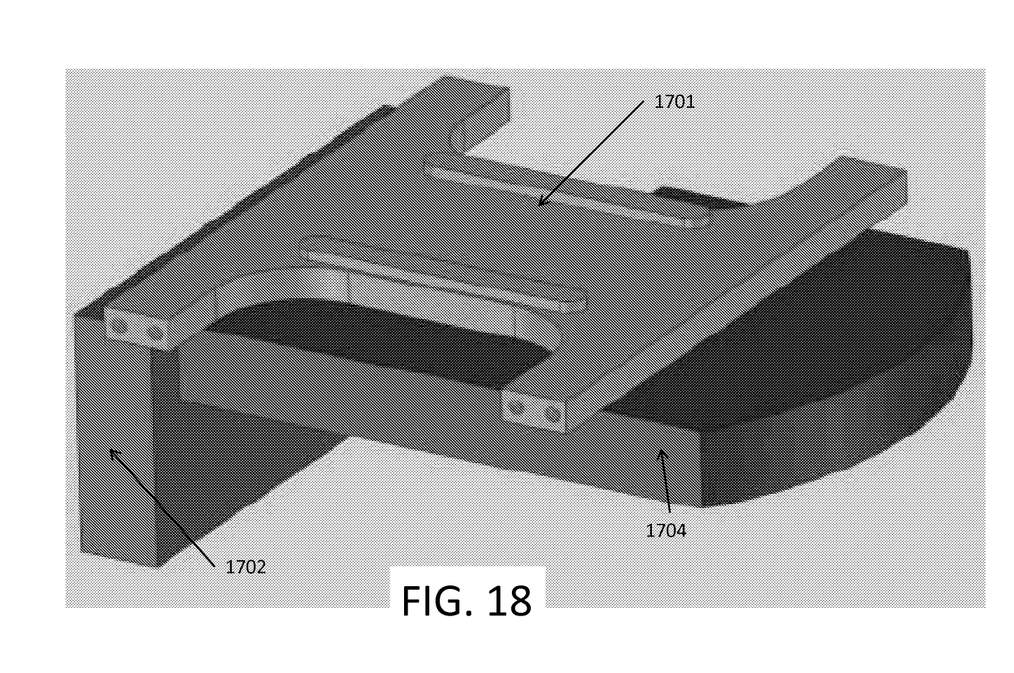

FIG. 18 is an illustration of the assembly of the horizontal support. The auxiliary board 1704 is installed directly on the Horizontal Support Base, and the Drive Board 1702 is mounted on the back of it. Other mounting relationships can also be suitable, see, e.g., FIG. 29.

FIG. 19 is an illustration of the box structure subassembly. This subassembly integrates the base subassembly 2001, the Access Side Riser subassembly 2002, the Drive Side Riser Subassembly 2003, the Horizontal Support Subassembly 2004. This subassembly isolates the pan and tilt functions, and allows temporary setting of cameras, AHRS, and Digital Video Interface boards. The digital video interface board transmits digital video streams to standard transfer forms, in this case HD-SDI. The Digital Video Interface board can interface with one or more cameras on the horizontal platform. This allows full electrical testing, and provides an easier environment for instrumentation of pan/tilt accuracy.

FIG. 20 is an illustration of the assembly of the box structure. The horizontal board is installed, for example with 8 2 mm screws 2005. The screws can be left slightly loose. The H assembly is mounted with the base, for example with 8 2 mm screws and 4 2 mm locating pins. After these screws are tightened, then the screws mounting the horizontal board can be tightened.

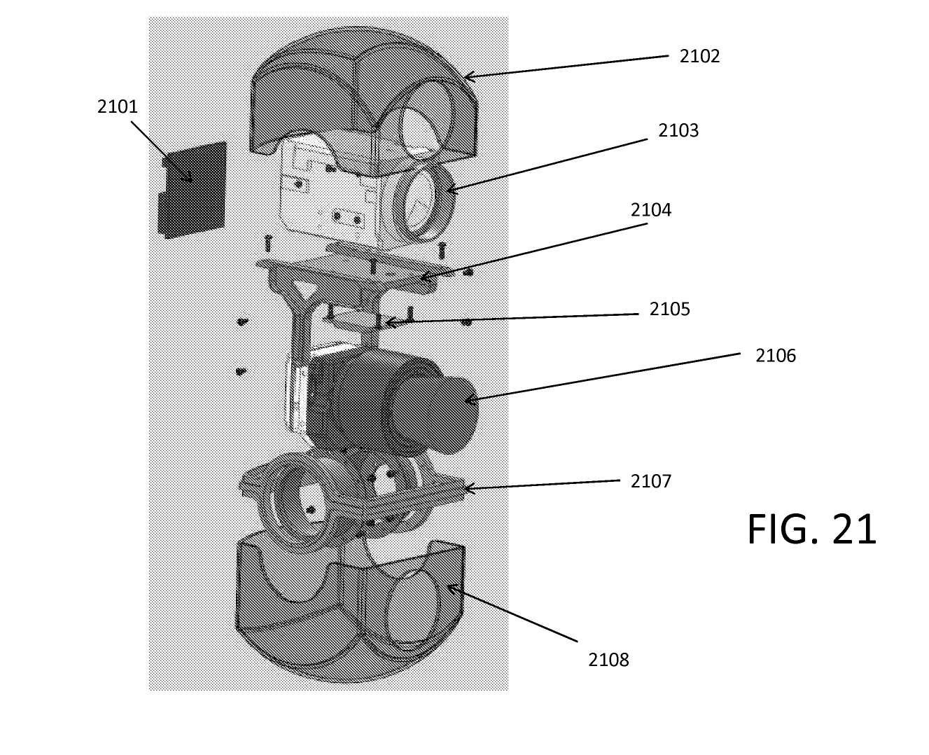

FIG. 21 is an illustration of the camera ball subassembly. The core structure can accommodate different camera sets, and the design allows cameras to be exchange in the field. The bracket that holds the camera(s), also called the “optical bench,” provides for rigid mechanical coupling, and thermal coupling, for two cameras (e.g., a visible light camera and an IR camera) and the Attitude Heading and Reference System (AHRS). The camera ball subassembly can be assembled in place within the base subassembly. The assembly comprises a digital video interface board 2101, a visible camera shell 2102, a visible light camera (E/O) 2103, an optical bench 2104, an AHRS 2105, an IR camera 2106, a camera ball shell structure 2107, and an IR shell 2108.

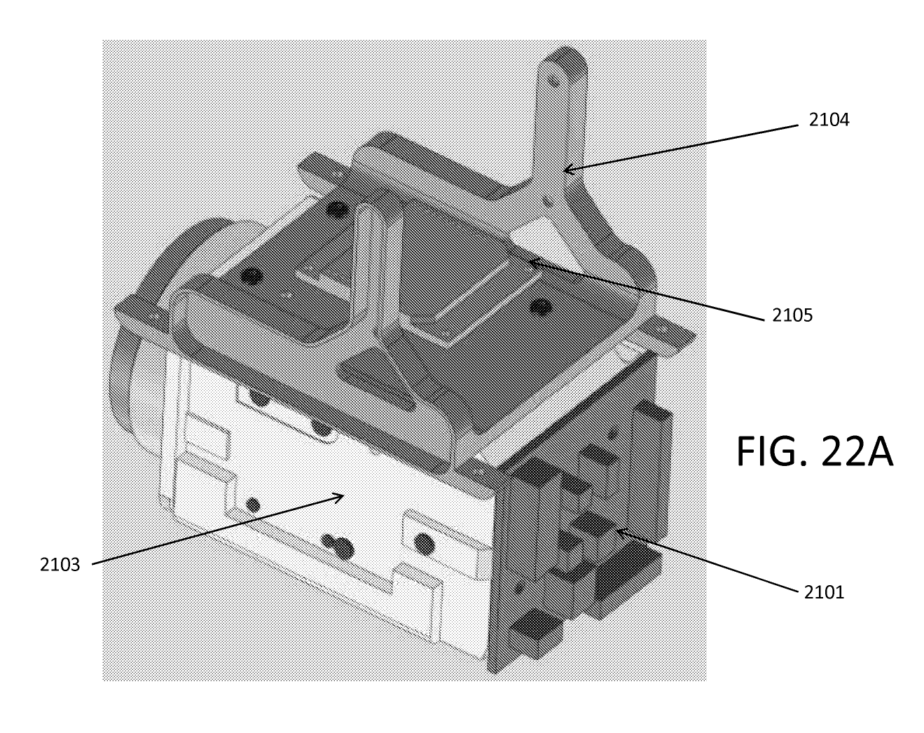

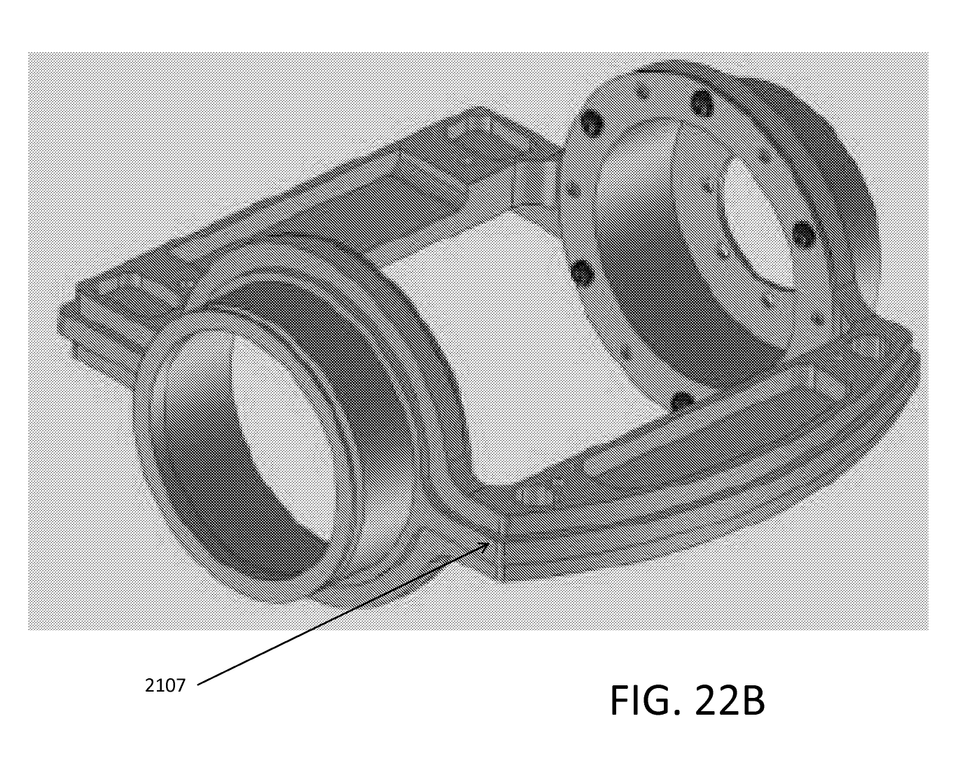

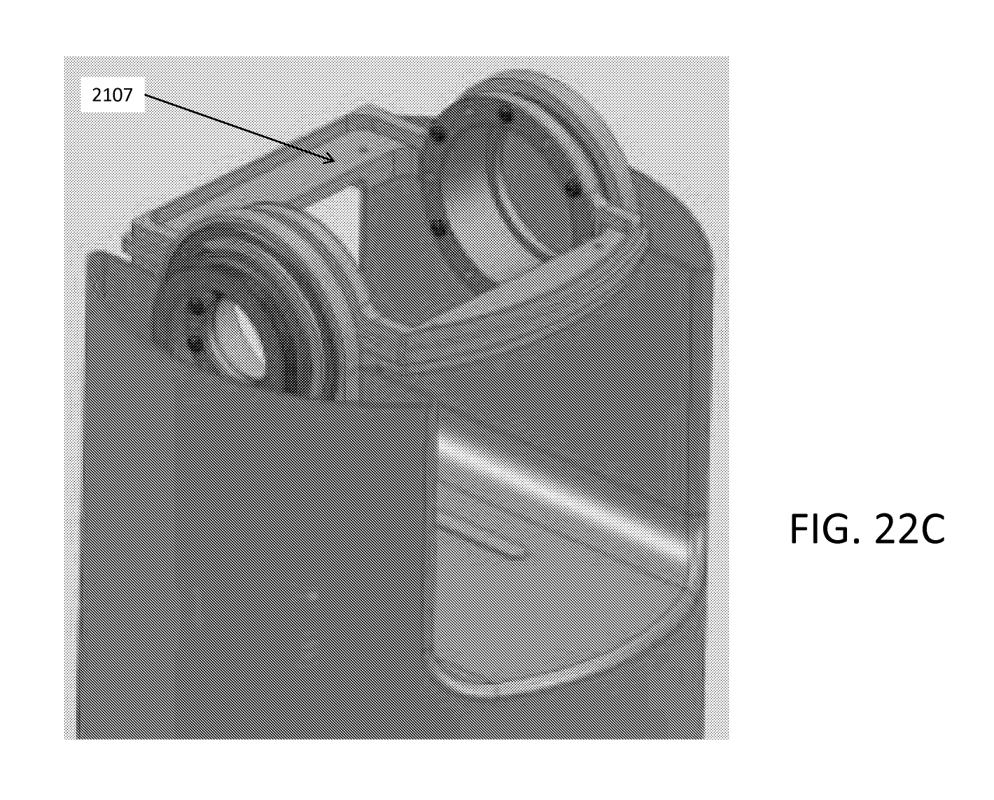

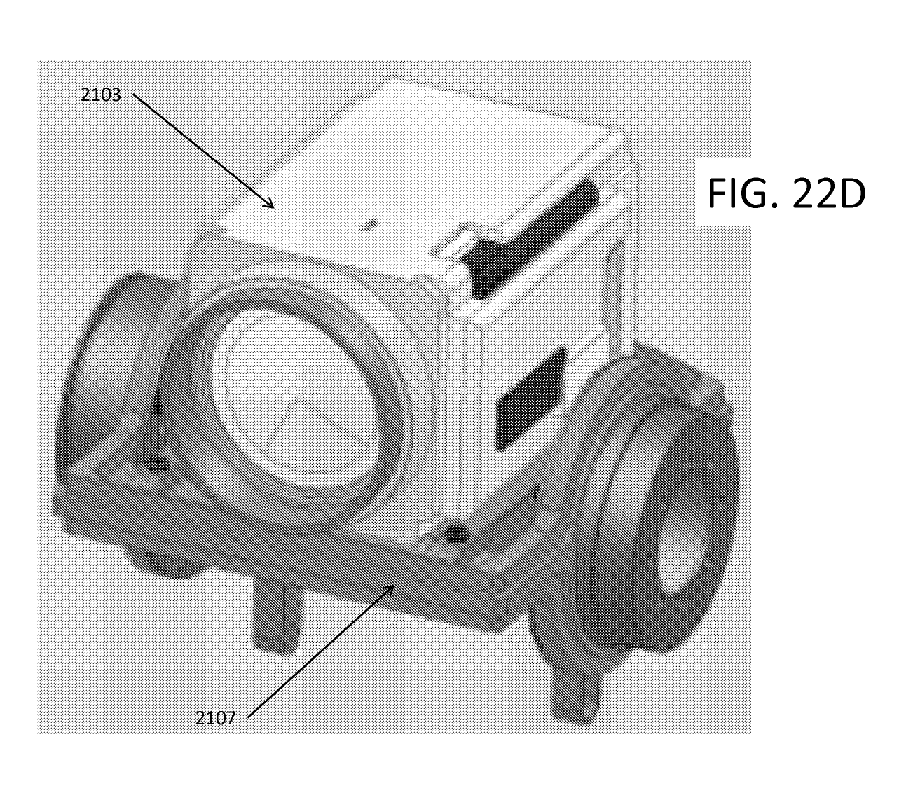

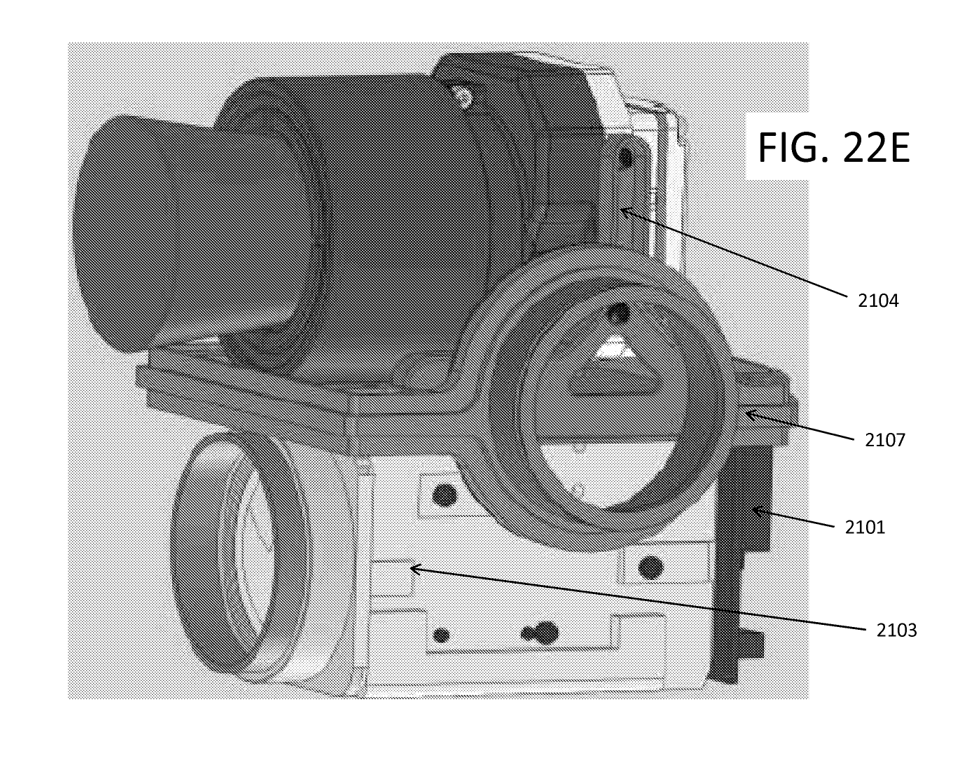

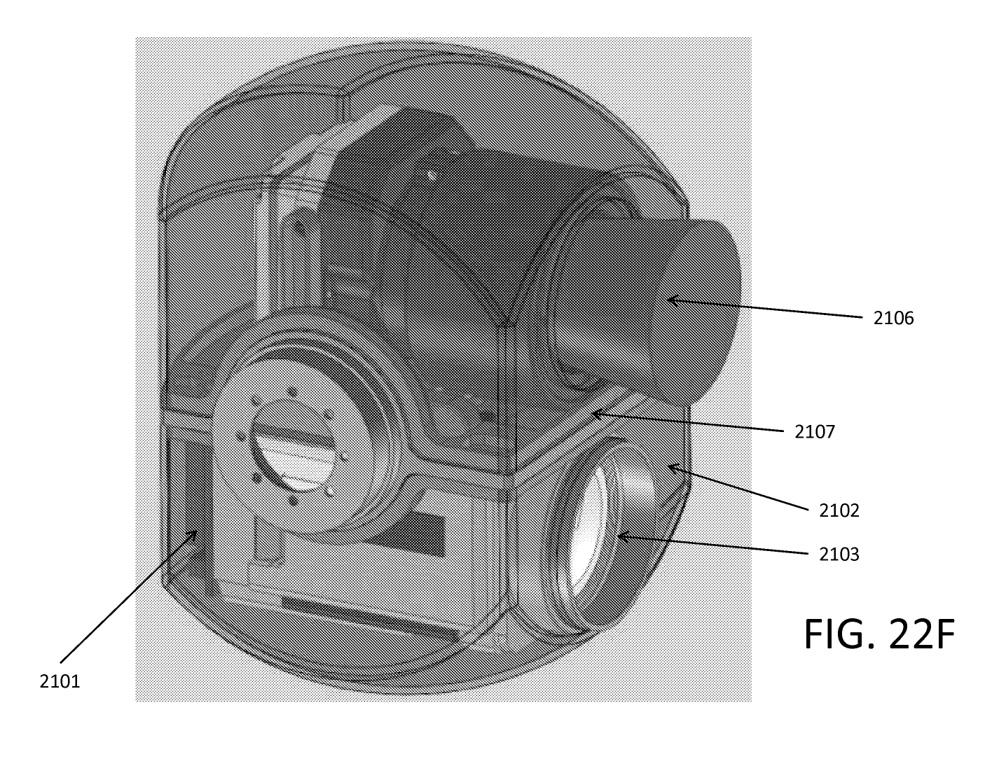

FIG. 22A through FIG. 22F provide an illustration of the assembly of the camera ball. In FIG. 22A, the AHRS board is installed, for example with 4 2 mm screws and appropriate mounting bosses. A first camera (e.g., a visible light camera) is installed, for example with 4 2 mm screws, and a ¼-20 screw (covered by the AHRS). The Digital Interface board is installed.

In FIGS. 22B and 22C, the camera ball shell structure 2107 is in place on the gimbal with the lower cover installed. The access side axle is installed, for example with 6 2 mm screws. A C-clip and shim on the access side can remove any bearing gap. The drive side axle is installed, for example using 6 2 mm screws. The 6 screws use the holes not already used by the drive pulley.

In FIGS. 22D and 22E, the optical bench 2104 with the visible light camera 2103 and AHRS 2105 is installed on the shell structure, for example using 4 2 mm screws. Clearances between structures can be kept small, e.g., about 0.010″ for rigidity. A second camera (e.g., an IR camera 2106) is installed, for example using 4 2 mm screws. Note that access to the lower screws can be difficult; a specially bent wrench can ease assembly. Wires are routed to the cameras.

In FIG. 22F, an IR shell slides over the center frame at the bottom, and can be sealed, for example with a 1 mm O-ring (not shown). The IR shell can be tilted during installation to allow a face sealing O-ring to clear the front of the lens. A visible light shell can also slide over the center frame, also sealed for example with a 1 mm O-ring. The lens of the visible light camera can be sealed after installation of the visible light shell.

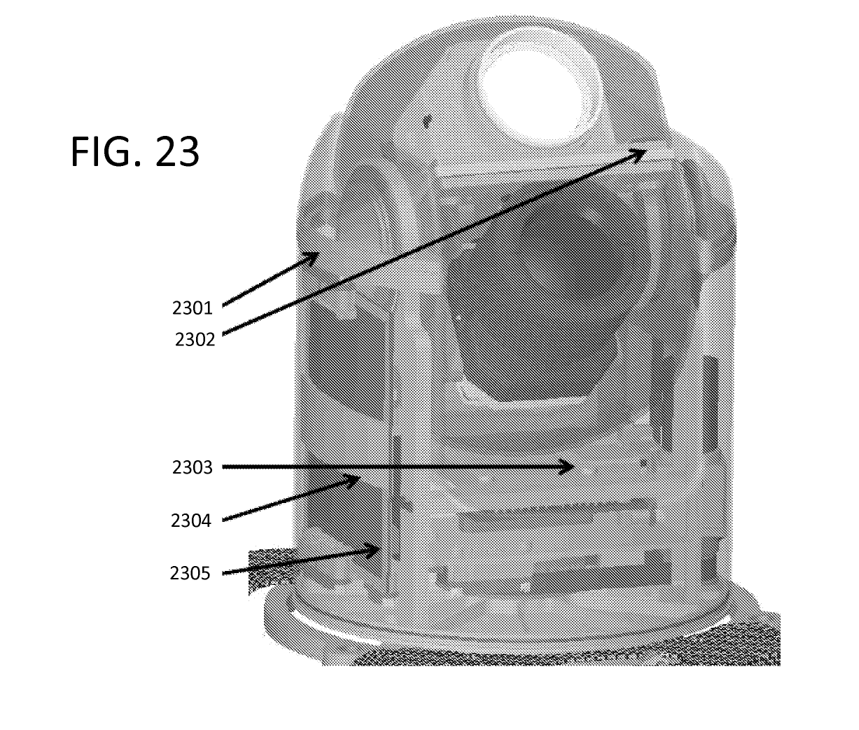

FIG. 23 is an illustration of an example embodiment, with several features highlighted that are important to the advantageous thermal performance: aluminum bands 2301 between the main yoke cover and the yoke ends; optical bench flange 2302, yoke fins 2303 near motor drivers, heatsink over image processing circuitry 2304, and thermal plane 2305. Differing system components and performance demands (e.g., heat production from the electronics) can indicate the appropriate design of the heatsink; the heatsink can be unnecessary in some applications. Generally, natural flow of air will be adequate to provide necessary heat transfer.

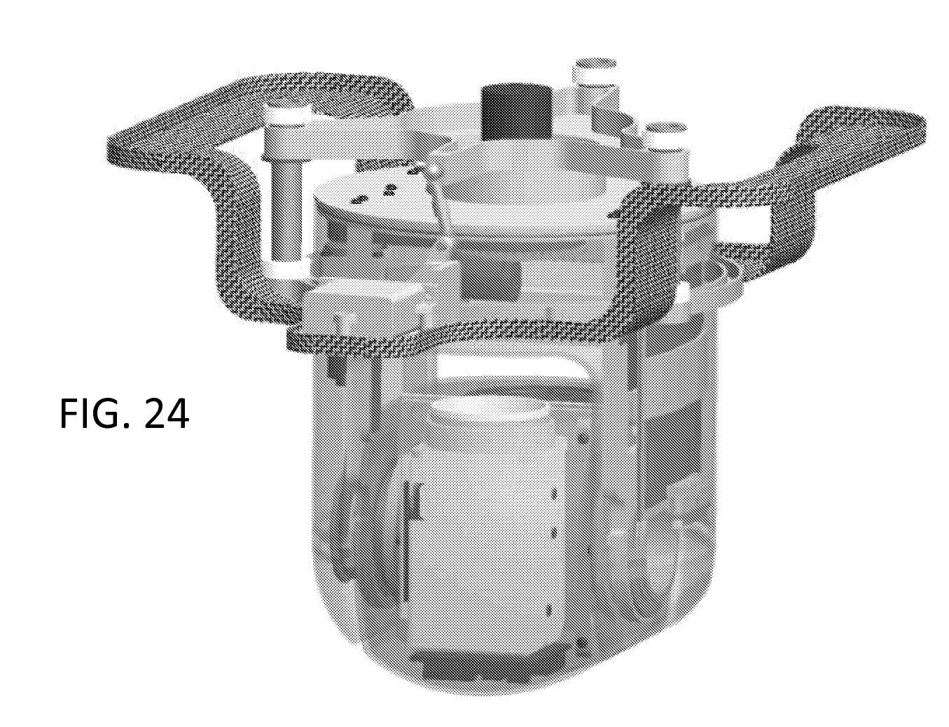

FIG. 24 is an illustration of a retraction mechanism used in an example embodiment. The gimbal retraction mechanism is for retracting the gimbal into and out of the body of an unmanned aerial vehicle aircraft. Using small electric motors and a cam mechanism, the entire gimbal and its mounting mechanism can be lowered below the air vehicle fuselage to allow greater field of view and range of motion while the imaging characteristics of the gimbal are in use. When the gimbal is not being used to provide imagery, or when it is desirable to have the gimbal further inside the fuselage of the aircraft, such as during takeoff and landing, adverse weather conditions or other environmental condition, the retract mechanism allows the gimbal to be retracted further into the aircraft fuselage to provide protection for the sensitive gimbal components.

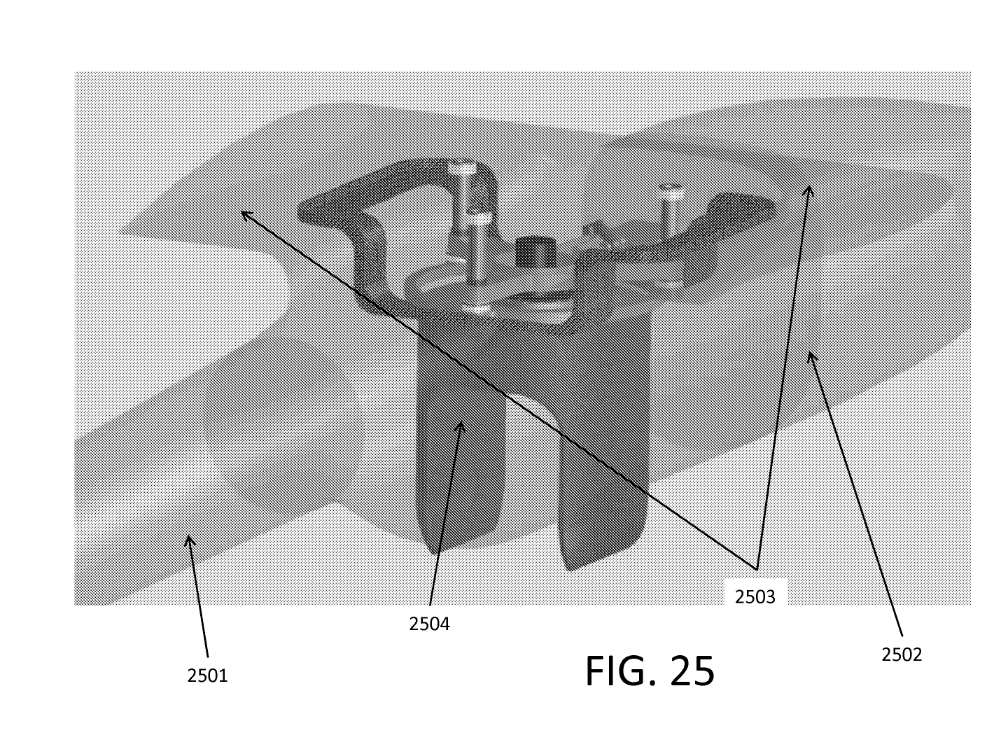

FIG. 25 is an illustration of the retraction mechanism 2504 in an UAS, comprising a fuselage section 2501 leading to the tail of the UAS, a fuselage 2502, wings 2503.

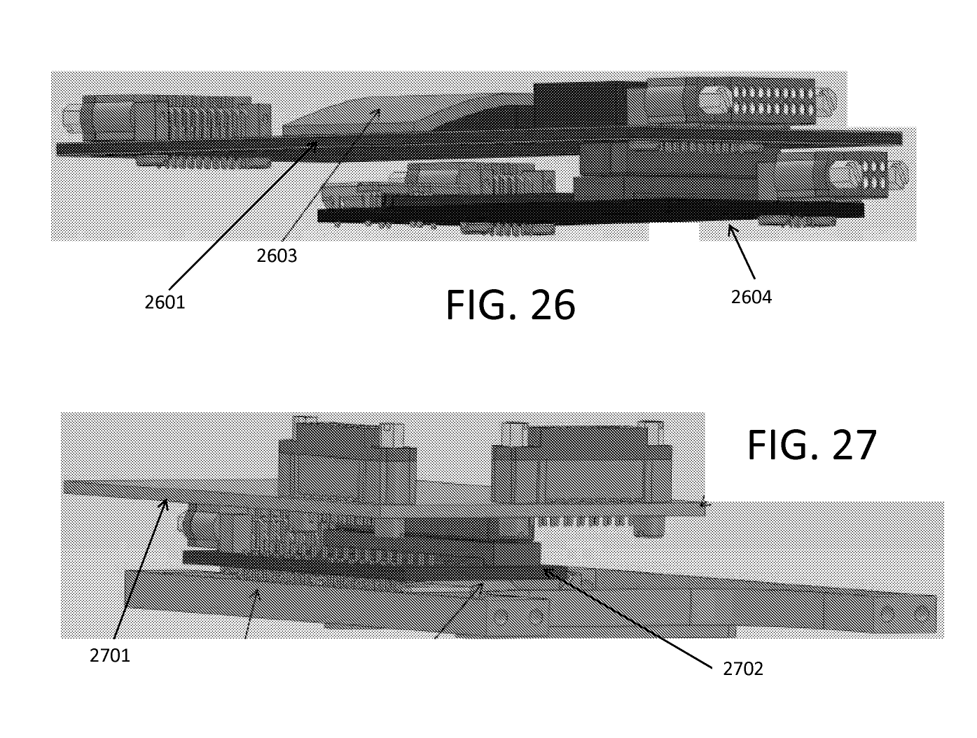

FIG. 26 is an illustration of a main circuit board. While the particular circuitry on the board can vary depending on current technology and performance needs, the arrangement shown can be suitable. A main board 2601 can accommodate communication and video processing. A daughter board 2602 can accommodate video interfaces. A heatsink 2603 for high heat devices, such as digital signal processing integrated circuits, can be tied to a thermal ground plane. The daughter board can be added to the system shown in the previous figures to perform the Video Interfacing to allow the Video Processing Computer to preserve its computing power for communications and video processing. In the figure, the Video Processing Computer is Green and the Daughter Board is Blue. In many of the following figures it can be difficult to see the Daughter board as it is mounted internally behind the Green Video Processing Computer.

FIG. 27 is an illustration of an auxiliary circuit board. While the particular circuitry on the board can vary depending on current technology and performance needs, the arrangement shown can be suitable. A main circuit board 2701 can accommodate a processor, sensor interfaces, and power supply. A motor drive board 2702 can have motor drive chips tied to the horizontal support for thermal dissipation.

Other embodiments can accommodate other payloads in the same basic gimbal structure. For example, a laser pointer device or a Short Wave Infrared (SWIR) camera or a Medium Wave Infrared Camera (MWIR) can be included.

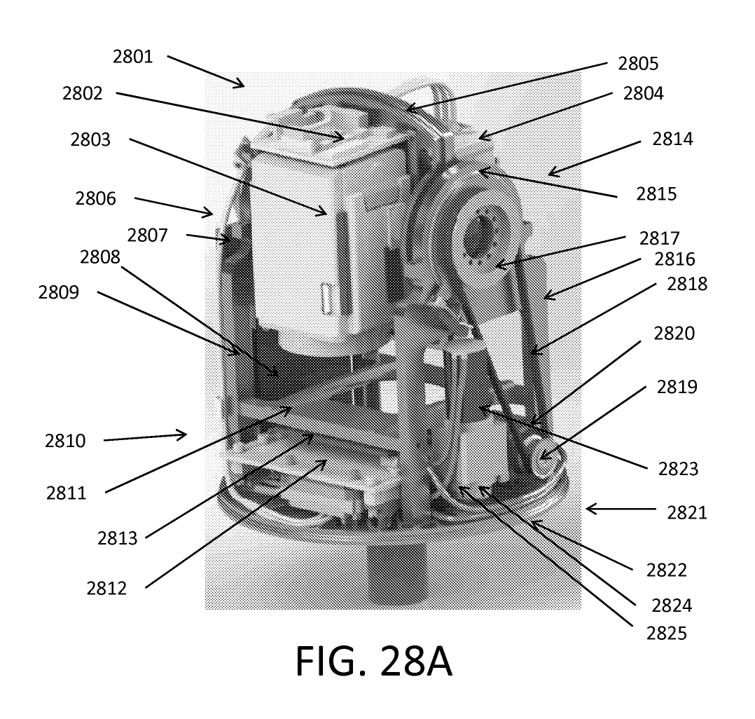

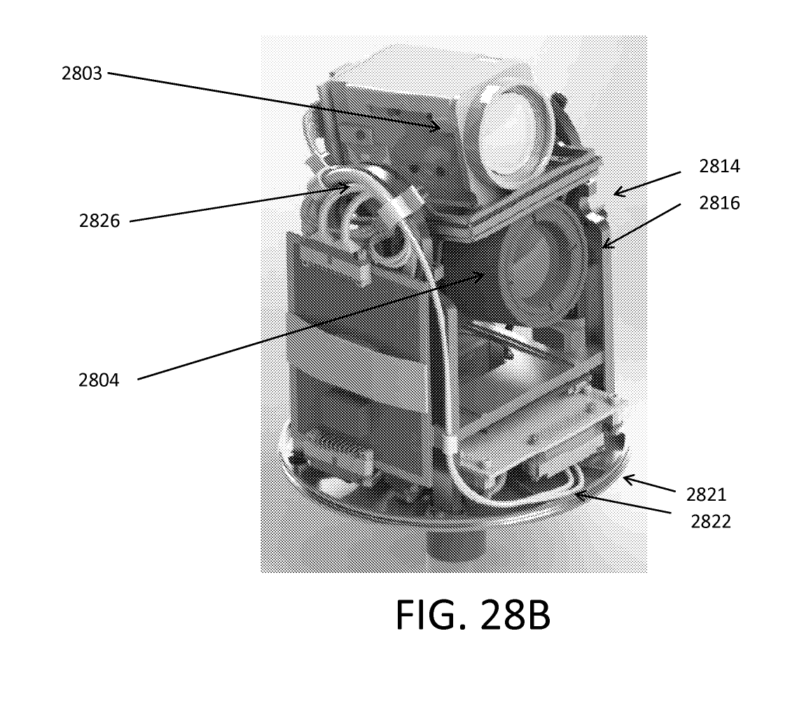

FIG. 28A, 28B provide an illustration of a fully assembled example embodiment. The illustrations show cable 2826 routing as well as the subassemblies discussed previously. The example embodiment comprises a Camera Ball Subassembly 2801 (Carbon Fiber shell not shown, cameras are facing down), comprising a digital video interface board 2802, a visible light camera 2803, an IR camera or mockup 2804, and a camera ball structure 2805. The example further comprises an access side riser subassembly 2806, comprising a video processing computer 2807, a daughter board 2808, and a riser frame 2809. The example further comprises a horizontal support subassembly 2810, comprising a horizontal support 2811, a drive board or motor and drive board 2812, and an auxiliary board 2813. The example further comprises a drive side riser subassembly 2814, comprising bearings 2815, riser frame 2816, top pulley 2817, belt 2818, pulley 2819, and bracket 2820. The example further comprises a base subassembly 2821, comprising a base 2822, a pan drive motor 2823, a pulley 2824 and a bracket 2825.

FIG. 29 is an illustration of optical switches and stops that can be used to prevent over rotation that could damage cables. A tab 2901, stop, and optical switches 2902 are configured so that the switch is interrupted if the tab is at the stop on either side. The components can be made and mounted with a structure 2903 such that they will flex in the event of impact. Mechanical stop tabs can be added for the Tilt function to ensure that the wires are protected from over rotation. When the gimbal is installed in the airframe and the camera ball facing down anything more than + or −90 deg of rotation will have the gimbal looking straight into the airplane. So, + or −90 tilt and continuous pan is acceptable for Airborne Situational Awareness.

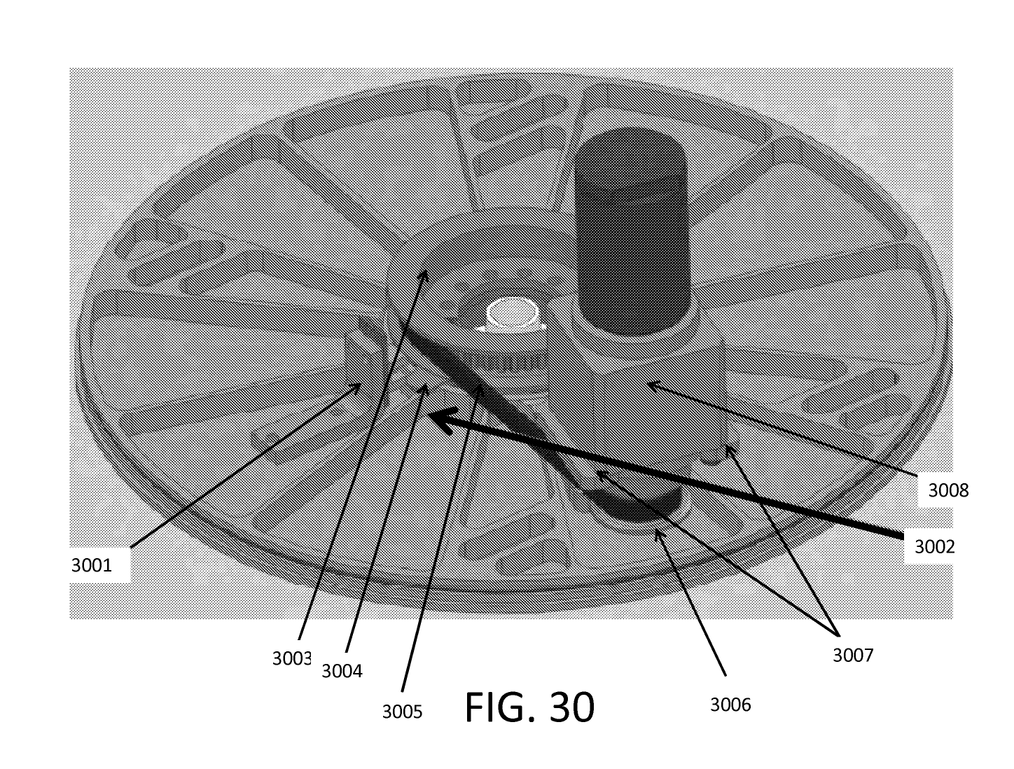

FIG. 30 is an illustration of a pan optical switch that can be suitable in some embodiments. An optical interrupter switch can provide an absolute encoder reference on power-up. The illustration comprises an optical interrupter switch 3001, a base 3002, a center pulley 3003, a tab 3004, a belt 3005, a pulley 3006, a pan motor bracket 3007, and a pan motor 3008.

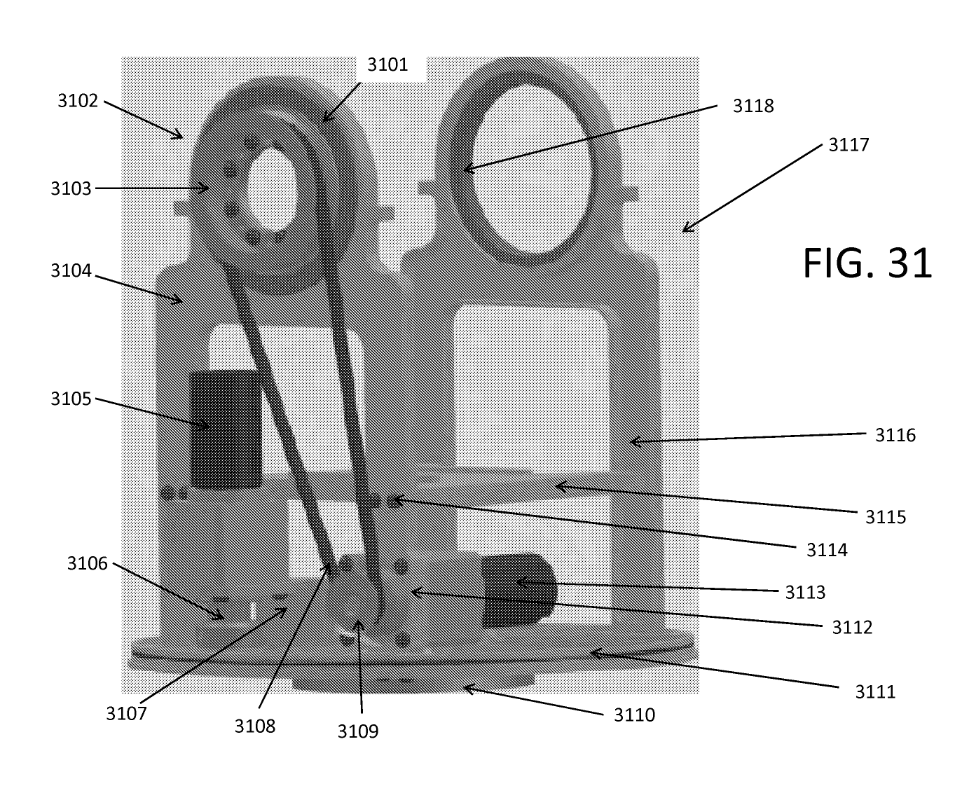

FIG. 31 is an illustration of an example embodiment with an alternate tilt motor arrangement. The tilt motor in the embodiment in the figure is integral to the drive side riser. The alternate arrangement can provide for more options for auxiliary circuit board designs. The example comprises a bearing and C clip 3101, a drive side riser subassembly 3102, a top pulley 3103, a riser frame 3104, a pan motor 3105, a pulley 3106, a pan drive motor bracket 3107, a belt 3108, a pulley 3109, a pan axle 3110, a base 3111, a bracket 3112, a tilt motor 3113, a PDR mounting 3114, a horizontal support 3115, a riser frame 3116, an access side riser subassembly 3117, and a bearing 3118.

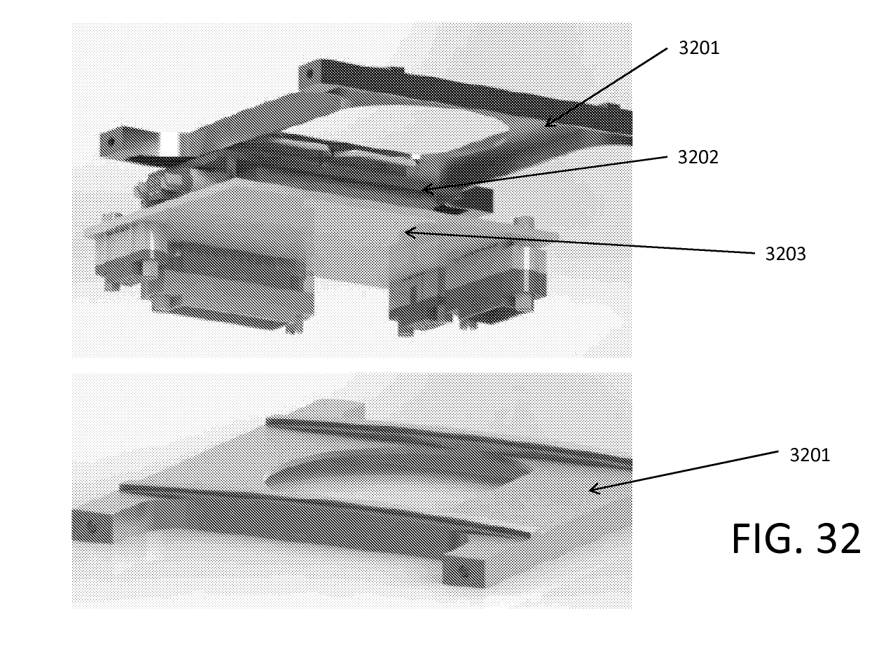

FIG. 32 is an illustration of an example embodiment with an alternate auxiliary circuit board and mount. In the figure, the motor drive integrated circuits are mounted directly to an aluminum cross frame. This can help dissipate heat more effectively. The cross support is curved to interface with a curved shell in the saddle. The Drive Board or Motor Board is directly mounted on the base or horizontal support cross. The example comprises a horizontal support 3201, a drive board, motor board, or motor drive board 3202, an auxiliary board or main board 3203.

The motor control can provide a “Safety Hide Feature” or “Camera Stow” mode feature that rotates the gimbal's cameras inside the gimbal housing to protect the cameras during takeoff and landings and in adverse weather conditions. When the cameras are rotated inside the gimbal ball, a portion of the gimbals hard casing becomes the bottom of the gimbal ball. Thus, a hardened part of the gimbal casing is what becomes exposed to the elements in takeoffs and landings and adverse weather conditions. This protects the sensitive cameras and electronics within the gimbal ball.

Those skilled in the art will recognize that the present invention can be manifested in a variety of forms other than the specific embodiments described and contemplated herein. Accordingly, departures in form and detail can be made without departing from the scope and spirit of the present invention as described in the appended claims.

We claim:

1. A gimbal and camera system suitable for providing high definition video in a small UAS.

2. A sensor system, configured to mount with a sUAS, comprising a camera configured to collect high definition video, and electronics providing real time image stabilization and downlink data stream compression.

3. A sensor system as in claim 2, configured to mount with a gimbal, and wherein the image processing hardware performing the image stabilization is configured to mount with the gimbal.

4. A sensor system as in claim 1, comprising a base subassembly, an access side riser subassembly mounted with the base, a drive side riser subassembly mounted with the base, a horizontal support subassembly mounted with the two side riser subassemblies, and camera ball subassembly mounted with the two side riser subassemblies.

5. A sensor system as in claim 4, wherein the camera ball subassembly comprises an infrared shell, a visible light shell, a visible light camera, and an infrared camera.

6. A sensor system as in claim 4, wherein the base subassembly is configured to provide for rotation of the camera ball subassembly about a first axis.

7. A sensor system as in claim 4, wherein the two side riser subassemblies are configured to provide for rotation of the camera ball subassembly about a tilt axis.

8. A sensor system as in claim 4, wherein the base subassembly is configured to provide for rotation of remainder of the system about a first axis, and wherein the two side riser subassemblies are configured to provide for rotation of the camera ball subassembly about a tilt axis, orthogonal to the first axis.

9. A sensor system as in claim 4, further comprising electronic circuit boards configured to provide control of the system, communications with the system, processing of information from the system, or a combination thereof; and wherein the electronic circuit boards are mounted with at least one of the subassemblies.

10. An unmanned aerial system, comprising a fuselage, and a sensor system as in claim 4.

11. An unmanned aerial system as in claim 10, wherein the sensor system comprises a sensor system as in claim 8.

12. A sensor system as in claim 7, wherein the two side riser subassemblies provide hollow mountings defining a tilt axle on which the camera ball subassembly rotates.

13. A sensor system as in claim 12, further comprising one or more cables configured to communicate information between subassemblies, and wherein at least one cable is routed through the center of the tilt axle.
